(19) United States
(12) Patent Application Publication
(10) Pub. No.: US 2009/0122340 A1
(43) Pub. Date: May 14, 2009

(54) INFORMATION PROCESSING APPARATUS, METHOD FOR CONTROLLING PRINT JOB, AND RECORDING MEDIUM HAVING INFORMATION PROCESSING PROGRAM RECORDED THEREON

(75) Inventor: Hitoshi Nagahama, Kyoto (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/270,548

(22) Filed: Nov. 13, 2008

(30) Foreign Application Priority Data
Nov. 13, 2007 (JP) 2007-294851
Nov. 10, 2008 (JP) 2008-288273

(51) Int. Cl. G06F 3/12

(52) U.S. Cl. 358/1.15

(57) ABSTRACT

A data communication section receives, from an input section, print job congestion information of all image forming apparatuses connected to a UWB wireless communication network and information to obtain distance between the information processing apparatus and the image forming apparatuses and orientation of the image forming apparatuses when viewed from the information processing apparatus. A calculating section calculates, based on the received information and a volume of data of print jobs to be outputted, to obtain the most efficient assignment of the print jobs for a unit of the number of copies. A control section controls the print jobs assigned by the calculating section and transmission of the print jobs to the image forming apparatuses from the data communication section.

### CROSS-REFERENCE TO RELATED APPLICATION

This application claims priority to Japanese Patent Application No. 2007-294851, which was filed on Nov. 13, 2007, and No. 2008-288273, which was filed on Nov. 10, 2008, the contents of which are incorporated herein by reference in its entirety.

### BACKGROUND OF THE INVENTION

1. Field of the Invention

The present invention relates to an information processing apparatus that is capable of wireless communication with a plurality of image forming apparatuses and that controls transmission of print jobs to the image forming apparatuses, a method for controlling the print jobs by the information processing apparatus, and a recording medium having an information processing program, recorded thereon.

2. Description of the Related Art

In recent years, with the performance improvement and low pricing of computers, a network system in which peripheral devices are shared using a network, particularly using a USB I/F (Universal Serial Bus Interface), to perform processing of information transmitted from a computer has been constructed. The USB I/F is capable of performing high-speed communication and large volume information communication, and is currently a well used interface.

Examples of the peripheral devices shared in the network system include image forming apparatuses such as a copier, a scanner, and an MFP (Multifunction Printer). By connecting a plurality of image forming apparatuses to a USB I/F to construct a network system, it becomes possible that print jobs transmitted from a computer are executed by the plurality of image forming apparatuses.

In such a network system, for each print job to be outputted, an image forming apparatus serving as an output destination thereof is usually specified at the time when an output instruction is given by the computer and each of print job is transmitted to the image forming apparatuses.

However, when transmitting/receiving recent image data having a large volume of photographic images or color graphic image data in the network system connected by a USB, a communication speed is so slow that the USB-connected network system is not suitable for performing a printing process of such data. In addition, since the USB is an interface for cable communication, it is necessary to connect to an image forming apparatus by an exclusive USB cable, and thereby degree of freedom of installation is considerably limited, resulting that the connecting work gets troublesome. Every time a layout is changed, a USB cable is required to be attached/detached, and due to increase in a frequency of the attachment/detachment, connection failure occurs at a USB port to thereby cause communication failure.

Furthermore, such a case can occur that print requests of a job are concentrated on a certain image forming apparatus, and even when a not-specified image forming apparatus is capable of printing jobs, print waiting of a job occurs at the image forming apparatus to which specification is concentratedly given, resulting that the image forming apparatus can not be used efficiently.

Furthermore, in a printing system in which a plurality of users share a plurality of image forming apparatuses, when processing print data transmitted from outside, in a case where the print data is transmitted to an image forming apparatus that executes a print job and, in accordance with printing situation of the image forming apparatus, the print job is processed by another printer, or where the print job has large amount of data and is thereby processed by a plurality of image forming apparatuses, the print data needs to be transferred again, resulting that it takes a lot of time and labor for the transfer.

In a print management apparatus described in Japanese Unexamined Patent Publication JP-A 2002-55795, a plurality of printers are collectively set to be a single virtual printer, and when print data is received, jobs are distributed to each printer within the virtual printer depending on the printing speed. When an instruction of a plural copies of printing is made, the number of copies is determined in accordance with a ratio of the printing speed in each printer.

A device network described in Japanese Unexamined Patent Application Publication JP-A 2004-515099 has a target device, a selecting device and a controller, wherein the controller determines whether the target device is selected by the selecting device by comparing orientation data with orientation which is derived from position data and the known position of the target device.

However, the conventional technology for image output mentioned above has the following problems.

That is, in the technologies disclosed in JP-A 2002-55795 and JP-A 2004-515099, since it is impossible to flexibly response to changes of processing states, for example, a process of performing automatic assignment for a unit of the number of copies depending on an amount of print jobs from a sender, is not available. Furthermore, since it is impossible, in view of distance between the sender of the print job and an image forming apparatus and orientation thereof, to determine the shortest route for the sender to go to receive a printed job, efficiency for obtaining the print job, including a time necessary to finally acquire a printed matter, and operation efficiency of the whole image forming apparatuses decrease.

### SUMMARY OF THE INVENTION

An object of the invention is to provide an information processing apparatus capable of improving operation efficiency of a plurality of image forming apparatuses by assigning print jobs for a unit of the number of copies, a method for controlling print jobs, and a recording medium having an information processing program recorded thereon.

The invention provides an information processing apparatus that is capable of wireless communication with a plurality of image forming apparatuses and controls transmission of print jobs to the image forming apparatuses, comprising:

a data communication section for receiving congestion information of print jobs in the plurality of image forming apparatuses, and information to obtain distance between the information processing apparatus and the image forming apparatuses and orientation of the image forming apparatuses when viewed from the information processing apparatus;

a calculating section for calculating, based on the information received by the data communication section, distance to the image forming apparatuses to be transmission destination of print jobs and orientation thereof;

a deciding section for deciding the image forming apparatuses obtained at the calculating section; and

a control section for controlling transmission of print jobs to the image forming apparatuses decided by the deciding section.

According to the invention, a data communication section of an information processing apparatus receives congestion information of print jobs in a plurality of image forming apparatuses, and information to obtain distance between the information processing apparatus and the image forming apparatuses and orientation of the image forming apparatuses when viewed from the information processing apparatus.

A calculating section calculates, based on each received information, distance to the image forming apparatuses to be transmission destinations of print jobs and orientation thereof. In accordance with the result obtained by the calculating section, a deciding section decides the image forming apparatuses as transmission destinations and a control section controls transmission of print jobs to the decided image forming apparatus.

Accordingly, it is possible to appropriately assign print jobs in consideration of all of a degree of job congestion in the image forming apparatuses and distance to the image forming apparatuses and orientation thereof, thus making it possible to improve operation efficiency of the image forming apparatuses.

Furthermore, in the invention, it is preferable that the data communication section performs communication of information with the plurality of image forming apparatuses by UWB wireless communication.

According to the invention, the data communication section receives, by UWB wireless communication, each of information of a degree of job congestion in the image forming apparatuses and information to obtain distance to the image forming apparatuses and orientation thereof, as well as performs transmission of print jobs.

Since the UWB wireless communication has not only a function of data communication but also a radar function of detecting distance to a communication object and orientation thereof, where high-speed and large volume communication is possible, it is possible to transmit even a print job including large volume image data (a full-color photographic image, a full-color graphic image and the like) in a short time.

Furthermore, in the invention, it is preferable that the data communication section is incorporated in the information processing apparatus and the plurality of image forming apparatuses or is externally connected thereto.

According to the invention, it is possible that the data communication section by wireless is incorporated in the information processing apparatus and the plurality of image forming apparatuses. In addition, by external connection, it is possible to add a function to an information processing apparatus and an image forming apparatus not having a function of wireless data communication.

Furthermore, the invention provides a method for controlling print jobs, wherein a plurality of image forming apparatuses and an information processing apparatus are constructed so as to be capable of wireless communication and the information processing apparatus controls transmission of print jobs to the image forming apparatuses, comprising:

receiving congestion information of print jobs in the plurality of image forming apparatuses, and information to obtain distance between the information processing apparatus and the image forming apparatuses and orientation of the image forming apparatuses when viewed from the information processing apparatus;

calculating, based on the received information, distance to the image forming apparatuses to be transmission destinations of print jobs and orientation thereof;

deciding the image forming apparatuses calculated and obtained by the calculating section; and

controlling transmission of print jobs to the decided image forming apparatuses.

According to the invention, congestion information of print jobs in the plurality of image forming apparatuses, and information to obtain distance between the information processing apparatus and the image forming apparatuses and orientation of the image forming apparatuses when viewed from the information processing apparatus are received.

Based on each received information, distance to the image forming apparatuses to be transmission destinations of print jobs and orientation thereof are calculated and obtained, and in accordance with the calculated and obtained result, the image forming apparatuses as transmission destinations are decided, and transmission of print jobs to the decided image forming apparatuses are controlled.

Accordingly, it is possible to appropriately assign print jobs for a unit of the number of copies in consideration of all of a degree of job congestion in the image forming apparatuses and distance to the image forming apparatuses and orientation thereof, thus making it possible to improve operation efficiency of the image forming apparatuses.

Furthermore, the invention may provide a recording medium having an information processing program for causing a computer to function as the information processing apparatus, recorded thereon.

### BRIEF DESCRIPTION OF THE DRAWINGS

Other and further objects, features, and advantages of the invention will be more explicit from the following detailed description taken with reference to the drawings wherein:

FIG. 1 is a block diagram showing the structure of an information processing apparatus according to a first embodiment of the invention;

FIG. 2 is a block diagram showing the structure of a image forming apparatus;

FIG. 3 is a block diagram of a transmitter constituting a UWB wireless communication section and a data communication section;

FIG. 4 is a block diagram of a receiver constituting the UWB wireless communication section and the data communication section;

FIG. 5 is a block diagram showing the structure of a UWB transmitter/receiver provided with a USB I/F;

FIG. 6 is a diagram showing a print property screen of a first image forming apparatus which is a color multifunctional peripheral;

FIG. 7 is a diagram showing display example of a detection screen;

FIG. 8 is a diagram showing display example of a setting screen;

FIG. 9 is a diagram showing another example of a setting screen;

FIG. 10 is a flowchart showing processing of job assignment by the information processing apparatus;

FIG. 11 is a perspective view of a mobile communication system according to a second embodiment of the invention;

FIG. 12 is another perspective view of the mobile communication system according to the second embodiment of the invention;

FIG. 13 is a perspective view of a display apparatus according to a third embodiment of the invention;

FIG. 14 is a block diagram of the display apparatus according to the third embodiment of the invention;

FIG. 15 is a diagram showing a print property screen;

FIG. 16 is a diagram showing a display example of a detection screen displayed with coordinate axes;

FIG. 17 is a schematic view showing linear distance from a position of a user (the image forming apparatus) to each of the image forming apparatuses;

FIG. 18 is a schematic view showing linear distance from a position of a user (a color printer) to each of the image forming apparatuses;

FIG. 19 is a view showing a display example of a movement route displayed on a monitor;

FIG. 20 is a view showing another display example of a movement route to be displayed on the monitor;

FIG. 21 is a view showing a display example where display on a map section is changed due to change in the direction of a user;

FIG. 22 is a view showing a display example of a detection screen;

FIG. 23 is a view showing a display example where display on a map section is changed due to change in the current position of a user; and

FIG. 24 is a flowchart showing another example of job assignment processing by the information processing apparatus.

### DETAILED DESCRIPTION

Now referring to the drawings, preferred embodiments of the invention are described below.

Embodiments of the invention will hereinafter be described with reference to the drawings.

### First Embodiment

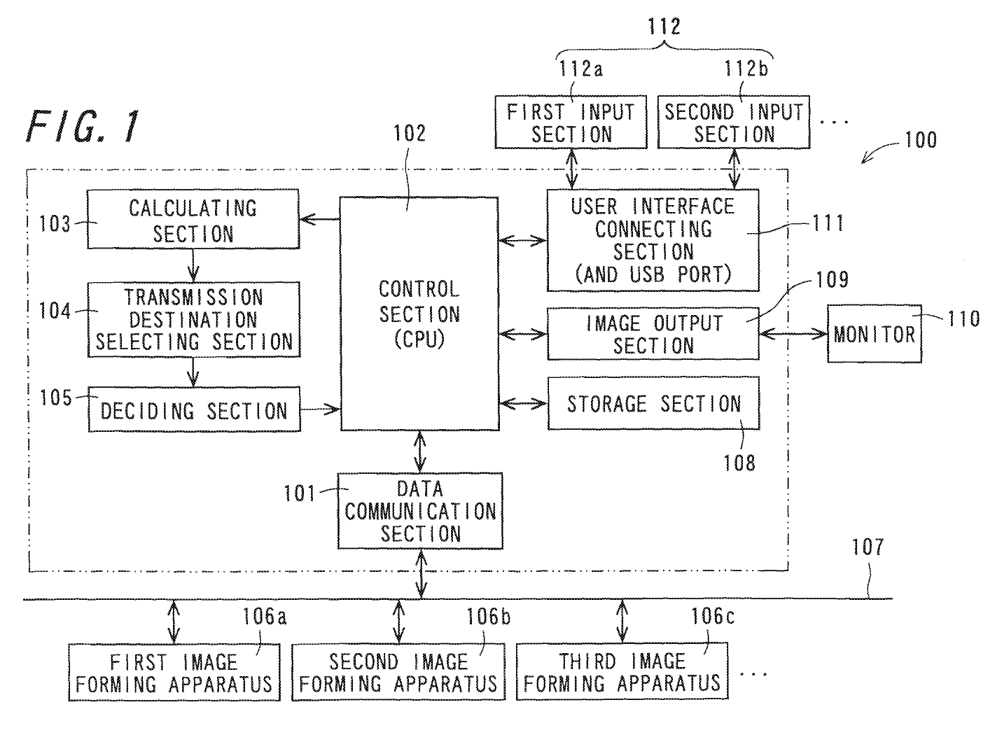

FIG. 1 is a block diagram showing the structure of an information processing apparatus 100 according to a first embodiment of the invention. The information processing apparatus 100 is realized by an apparatus capable of creating image data and outputting a print job, such as a personal computer (hereinafter referred to as a PC).

The information processing apparatus 100 is formed with a plurality of image forming apparatuses 106 (106a, 106b, and 106c) such as a multifunctional peripheral and a UWB wireless communication network 107. Note that, in the present embodiment, three image forming apparatuses of the first image forming apparatus 106a, the second image forming apparatus 106b and the third image forming apparatus 106c are connected through the UWB wireless communication network 107, but the number of the apparatuses is not limited to three as long as UWB wireless communication is available.

The UWB wireless communication network 107 is a network for performing data communication utilizing UWB wireless communication as a standard of wireless communication. The UWB wireless communication is an abbreviation of Ultra Wide Band communication and refers to ultra wideband wireless communication.

In the UWB wireless communication, a frequency band is 3.1 to 10.6 GHz, a bandwidth is 7.5 GHz, transmission power is 0.1 to 0.5 mW and communication speed is equal to or more than 480 Mbps and less than 2 Gbps. Furthermore, by using such radio wave, not only data communication but also a radar function of detecting distance to a communication object and orientation thereof is provided.

The information processing apparatus 100 includes a data communication section 101, a control section 102, a calculating section 103, a transmission destination selecting section 104, a deciding section 105, a storage section 108, an image output section 109 and a user interface connecting section 111.

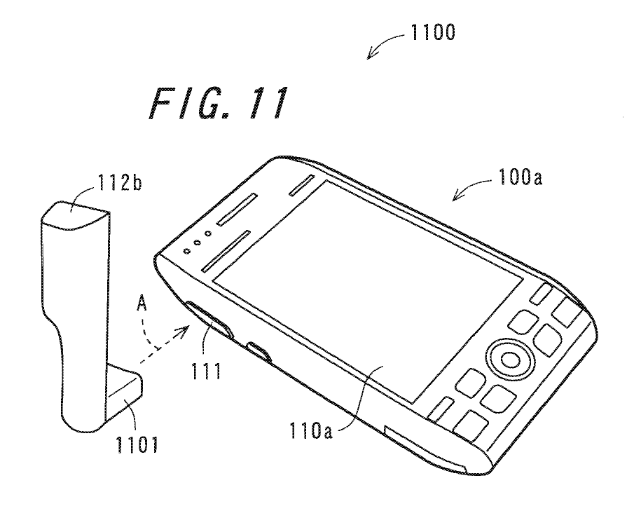

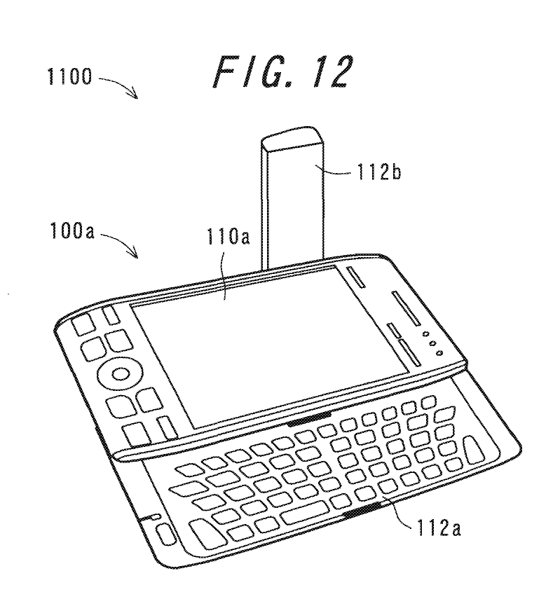

Connected to the user interface connecting section 111 are input sections 112 of a first input section 112a such as a mouse, a key board or a touch panel, and an externally connected second input section 112b capable of wireless data communication (refer to a UWB wireless communication adaptor in FIGS. 11 and 12 below), and when a user operates the first input section 112a, the information processing apparatus 100 performs the operation desired by the user.

Note that, the information processing apparatus 100 in FIG. 1 incorporates the data communication section 101, and is therefore not connected to the second input section 112b (UWB wireless communication adaptor). Moreover, a monitor 110 is connected to the image output section 109, and the image output section 109 converts and outputs image data created by the control section 102 so that an image is displayed on the monitor 110.

Transmission of a print job from the information processing apparatus 100 to the image forming apparatuses 106 is performed through the UWB wireless communication. Transmission destinations of the print job, that is, an output destination of the print job may be selected among a plurality of image forming apparatuses 106 by the user, however, when the information processing apparatus 100 selects the image forming apparatus based on distance to the information processing apparatus 100 and orientation thereof, a job congestion state, and data volume of the job to be transmitted, it is possible to improve operation efficiency of the image forming apparatuses.

After the user decides the print job to be outputted, upon an operation by the user, an instruction is input to obtain congestion information of print jobs from the input section 112a to the image forming apparatuses 106 and information to obtain distance between the information processing apparatus and the image forming apparatuses and orientation of the image forming apparatuses when viewed from the information processing apparatus, and the instruction to obtain is then sent through the user interface connecting section 111 to the control section 102.

The instruction to obtain each information is sent from the control section 102 to the data communication section 101, and to all of the image forming apparatuses 106 connected through the data communication section 101 to the UWB wireless communication network 107, the congestion information of print jobs and the information to obtain distance between the information processing apparatus and the image forming apparatuses and orientation of the image forming apparatuses when viewed from the information processing apparatus are transmitted.

Response information replied to the transmitted information includes the job congestion information for each image forming apparatus, and the information to obtain distance and orientation.

The first image forming apparatus 106a, the second image forming apparatus 106b and the third image forming apparatus 106c return, as the response information, the job congestion information of their own, the information to obtain distance and orientation to the information processing apparatus 100.

When the data communication section 101 receives the response information including the job congestion information and the information to obtain distance and orientation, transmitted from each of the image forming apparatuses 106, the response information is sent through the control section 102 to the storage section 108.

The storage section 108 stores a time t1 when the congestion information of print jobs and the information to obtain distance between the information processing apparatus and the image forming apparatuses and orientation of the image forming apparatuses when viewed from the information processing apparatus are transmitted from the data communication section 101 to all of the image forming apparatuses 106 and a time t2 when the response information transmitted from the image forming apparatus 106a and other image forming apparatuses is received.

Information of the respective times t1 and t2 is sent to the calculating section 103, and based on a time difference between t1 and t2, distance between the information processing apparatus 100 and the image forming apparatus 106a and other image forming apparatuses is calculated and obtained.

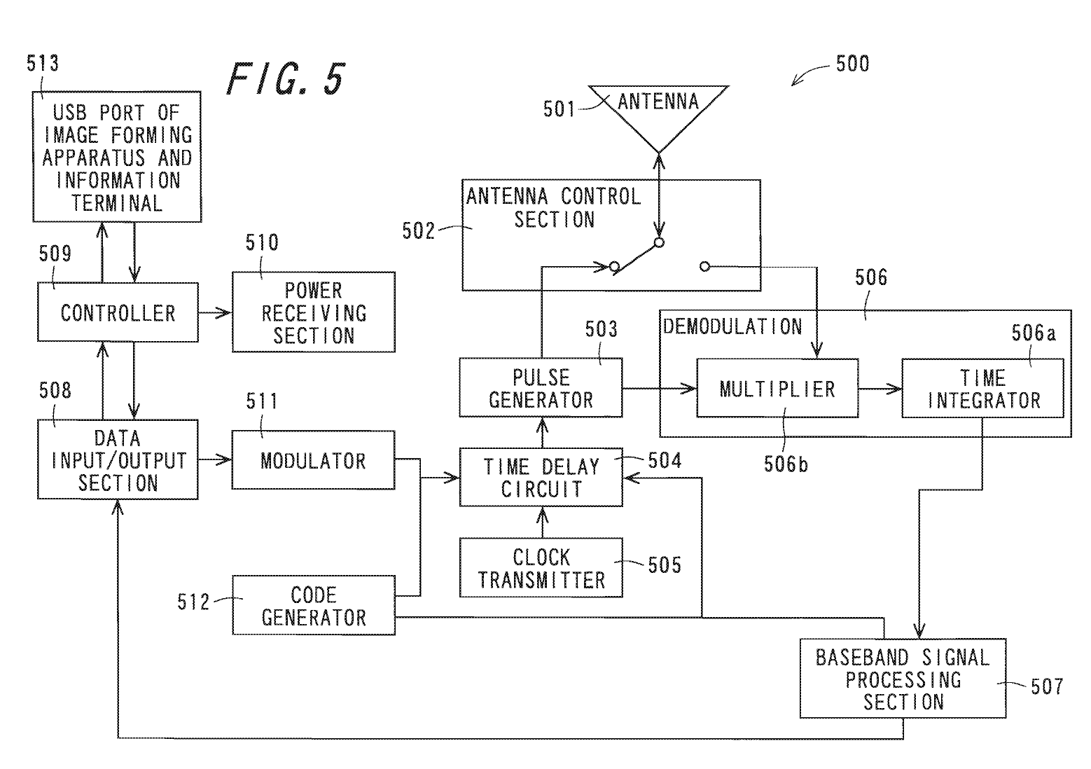

The data communication section 101 is provided with an antenna 501 (FIG. 5) described below.

In a case where the antenna 501 (FIG. 5) is a non-directional antenna, an intensity of the voltage standing wave ratio (VSWR) of the UWB radio wave from the image forming apparatus 106a and other image forming apparatuses is utilized. A radiation pattern A of the UWB radio wave transmitted from the antenna 501 (FIG. 5) is changed to a distorted radiation pattern B after the UWB radio wave from the image forming apparatuses 106a and other image forming apparatuses causes distortion.

The radiation pattern A of the UWB radio wave transmitted from the antenna 501 (FIG. 5) and the changed radiation pattern B are stored in the storage section 108. Information of the radiation pattern A and the distorted radiation pattern B are sent to the calculating section 103, and by comparing the radiation pattern A with the distorted radiation pattern B, orientation having greater distortion is calculated to obtain orientation of the image forming apparatuses 106a and other image forming apparatuses.

In addition, in the case of a directional antenna, as many pieces as necessary can be attached to obtain orientation of the image forming apparatus 106a and other image forming apparatuses.

The calculating section 103 calculates, based on the response information received from the plurality of image forming apparatuses 106 and data volume of print jobs to be outputted, to obtain the most efficient assignment of the prints job for a unit of the number of copies.

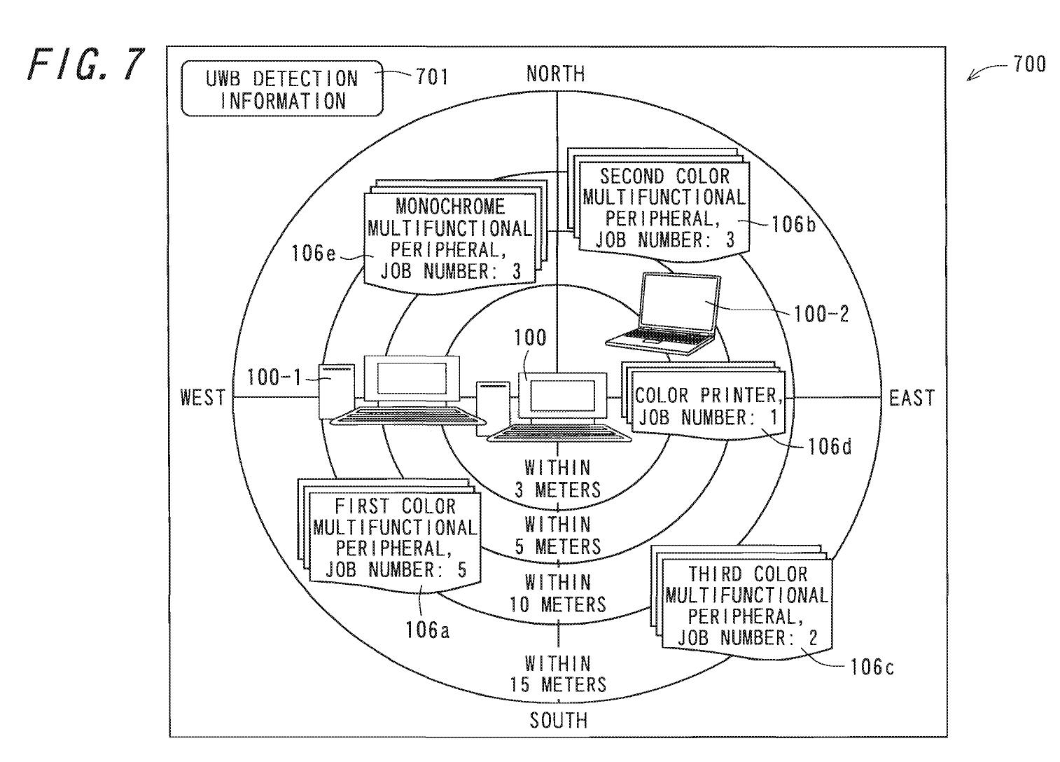

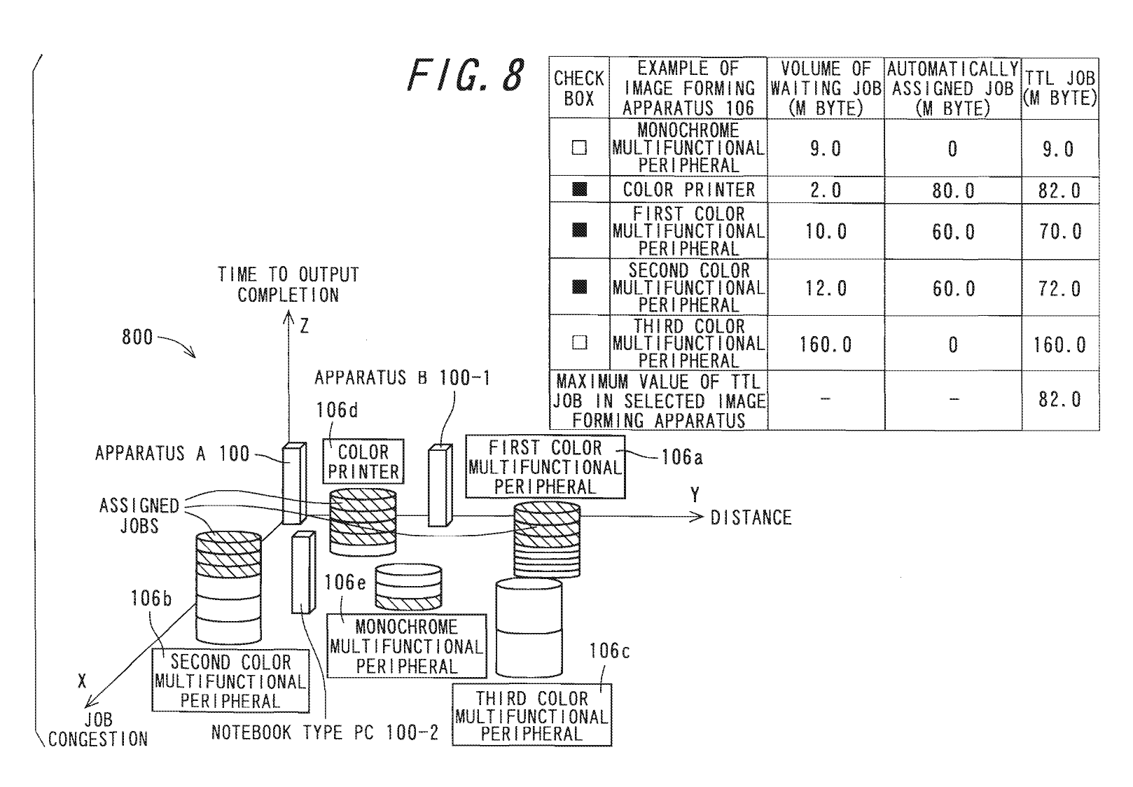

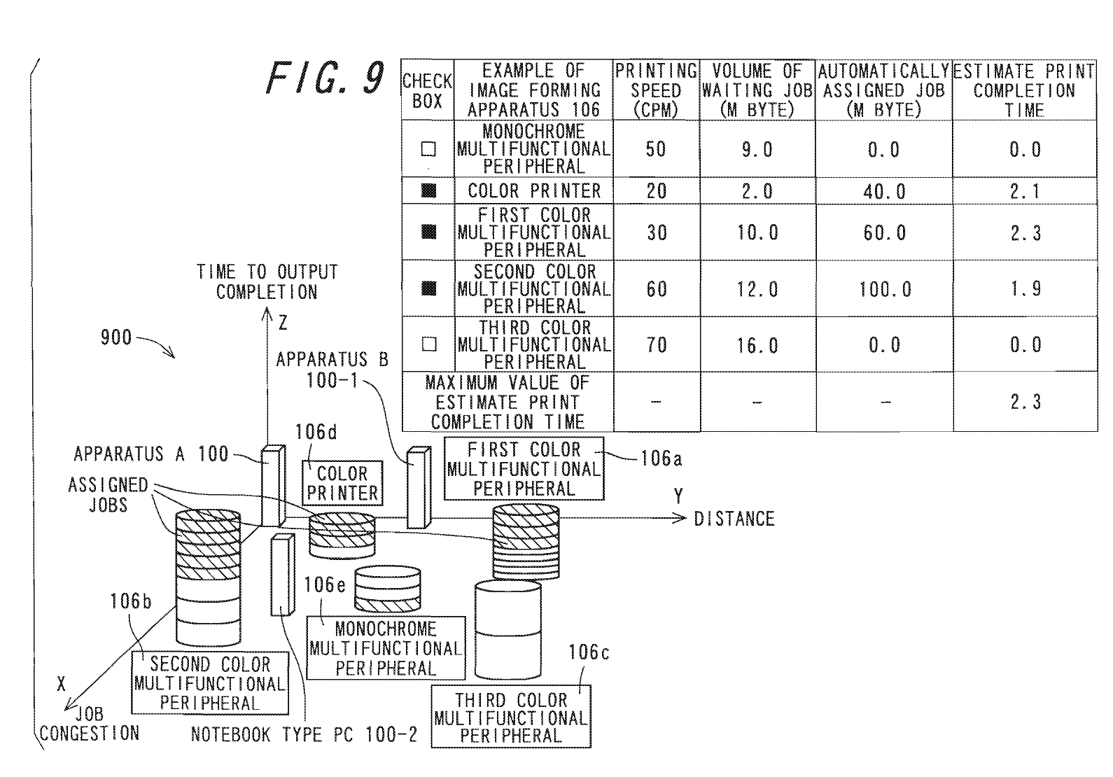

The calculating section 103 calculates to obtain, specifically, contents displayed on a detection screen 700 of FIG. 7, a setting screen 800 of FIG. 8 and another example of a setting screen 900 of FIG. 9, which will be described below.

The transmission destination selecting section 104 selects, based on the calculation result of the calculating section 103, an image forming apparatus to which the assigned print job is to be sent among the image forming apparatuses that have replied the response information. The selection result is sent to the deciding section 105.

The deciding section 105 decides the selection result of the transmission destination selecting section 104 and sends the decision result through the control section 102 to the data communication section 101, and a print execution instruction, in which the print jobs are assigned for a unit of the number of copies, is sent from the data communication section 101 to each of the image forming apparatuses 106.

With a series of the information processing, the congestion state of the print jobs at the plurality of image forming apparatuses 106, assignment of the print jobs for a unit of the number of copies, and distance to the image forming apparatuses and orientation thereof are calculated, and this makes it possible to give an instruction to execute the print jobs most efficiently.

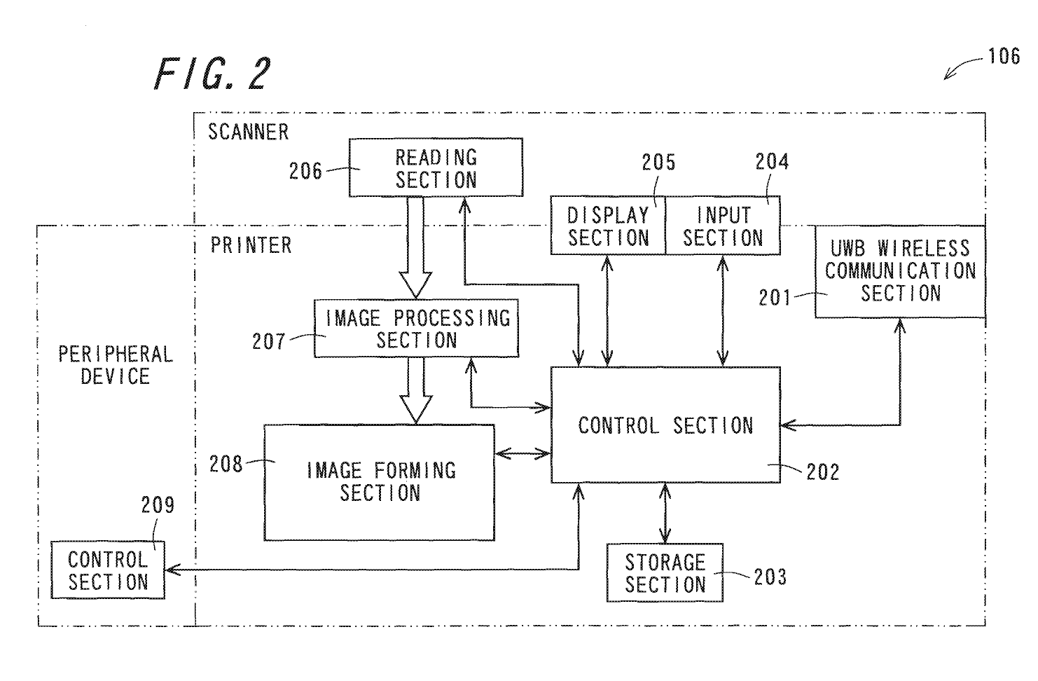

FIG. 2 is a block diagram showing the structure of the image forming apparatus 106. Since the first image forming apparatus 106a, the second image forming apparatus 106b and the third image forming apparatus 106c are same in structure, description will be given for the image forming apparatus 106 collectively.

The UWB wireless communication section 201 receives the job congestion information of the image forming apparatus 106 and information to obtain distance between the information processing apparatus and the image forming apparatus and orientation of the image forming apparatus when viewed from the information processing apparatus, which are transmitted from the data communication section 101. The respective received information is sent to the control section 202. The control section 202 reads the current congestion information of print jobs stored in the storage section 203 to send to the UWB wireless communication section 201. The UWB wireless communication section 201 replies the job congestion information of the print jobs to the information processing apparatus 100.

Since the congestion information of the print jobs is the UWB radio wave, the information processing apparatus 100 is able to calculate distance to the image forming apparatus 106 and orientation thereof using the intensity of the voltage standing wave ratio (VSWR).

The image forming apparatus 106 is, for example, a multifunctional peripheral provided with a scanner, a printer and a peripheral device, and includes a reading section 206 for reading a document image, an image processing section 207 for converting the read document image into an appropriate electric signal to generate image data, an image forming section 208 for printing to output the generated image data, a peripheral device control section 209 for controlling peripheral devices such as a finisher or a sorter which are a post-processing apparatus, an input section 204 which is an operation section of the image forming apparatus 106, and a display section 205.

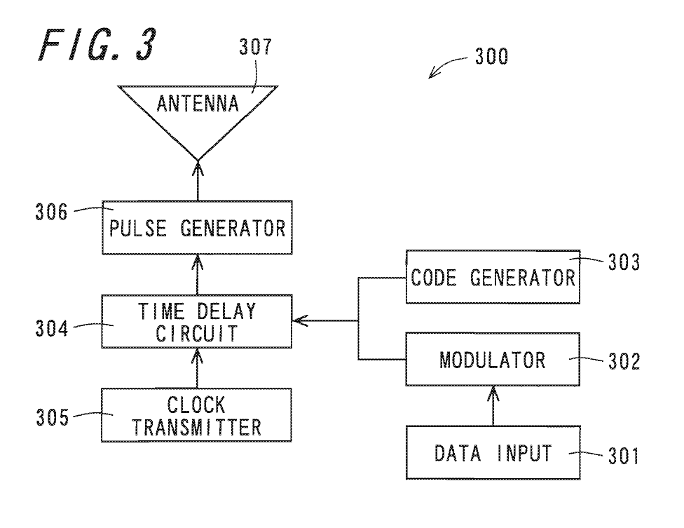

FIG. 3 is a block diagram of a transmitter 300 constituting the UWB wireless communication section 201 and the data communication section 101.

The UWB wireless communication is short-pulse communication, in which, for example, when the transmitter is incorporated in the image forming apparatus 106, read job congestion information is input into a data input 301, and data modulated by a modulator 302 and a signal generated by a code generator 303 are sent together to a time delay circuit 304. The time delay circuit 304 applies equalization processing of waveform delay and distortion in a communication path, followed by transmission to a pulse generator 306 with clock signal of a clock generator 305, and then the job congestion information is pulse-transmitted as a short pulse from an antenna 307.

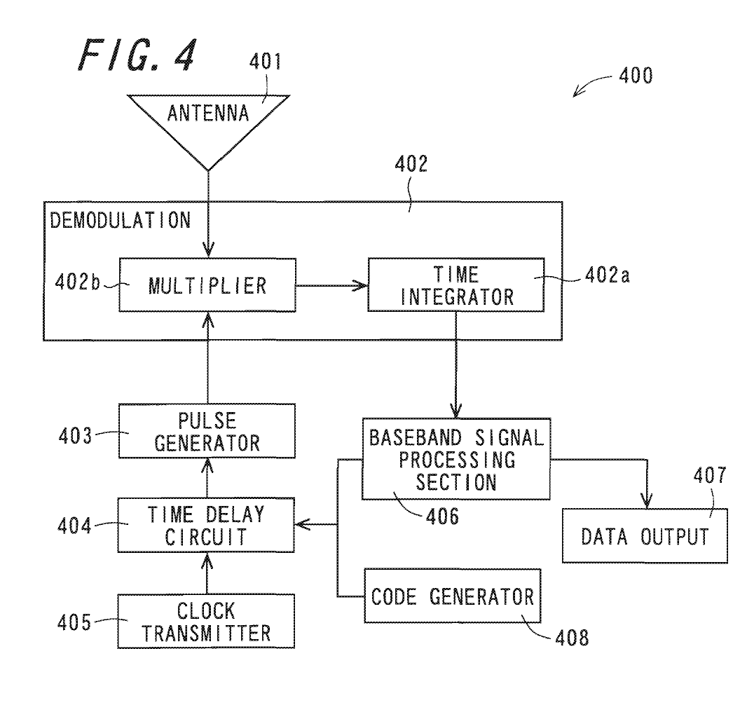

FIG. 4 is a block diagram of a receiver 400 constituting the UWB wireless communication section 201 and the data communication section 101.

A pulse transmitted from the antenna 307 of the transmitter is received by an antenna 401. The received pulse is demodulated by a demodulator 402. The demodulation is correlation detection to the received pulse waveform. The demodulator 402 is referred to as a matching filter, and passes through a time integrator 402a and a multiplier 402b to be subjected to signal processing at a baseband signal processor 406, so that job congestion information is outputted as an output signal from a data output 407.

The multiplier 402b is formed with a loop that transmits a signal from the baseband signal processor 406 and a signal from a code generator 408 together to a time delay circuit 404, and together with a clock generated by a clock transmitter 405, and is connected to a multiplier 402b through a pulse generator 403 with clock generated by the clock generator 405.

The antenna 401 of the receiver is not shown in detail in the figure, which is a non-directional antenna using a discone antenna. In the case of a directional antenna, as many antenna as necessary may be attached.

FIG. 5 is a block diagram showing the structure of a UWB transmitter/receiver 500 provided with a USB I/F. The UWB wireless communication section 201 and the data communication section 101 may be configured so as to include a transmitter and a receiver as described above or may be configured so as to include an integral transmitter/receiver, which will be described below.

The pulse transmitter/receiver 500 is configured by combining the transmitter 300 shown in FIG. 3 and the receiver 400 shown in FIG. 4. It is possible to operate by switching transmission and reception of a pulse by an antenna control section 502.

When being operated as the transmitter, the antenna control section 502 is switched so as to connect the antenna 501 and a pulse generator 503. When information to be transmitted is input into a data input/output section 508, data modulated at a modulator 511 and a signal from a code generator 512 are sent together to a time delay circuit 504. The time delay circuit 504 applies equalization processing of waveform delay and distortion in a communication path, followed by transmission to the pulse generator 503 with clock signal of a clock transmitter 505 and pulse-transmission as a short pulse through the antenna control section 502 from the antenna 501.

When being operated as the receiver, the antenna control section 502 is switched so as to connect the antenna 501 and a demodulator 506.

The pulse received by the antenna 501 is demodulated by the demodulator 506. The demodulator 506 passes through a time integrator 506a and a multiplier 506b to be subjected to signal processing at a baseband signal processor 507, so that received information is outputted from a data input/output section 508 as an output signal.

The transmitter/receiver 500 provided, with a USB I/F is capable of UWB wireless communication with a terminal apparatus or an image forming apparatus, in which no UWB transmitter/receiver is incorporated, when connected to the transmitter/receiver 500 through a USB port.

The transmitter/receiver 500 is also referred to as a wireless USB (Wireless USB).

For example, it is connected to a USB port 513 of the information processing apparatus 100 and the image forming apparatus 106 through a controller 509 and by sending from the controller 509 to a power receiving section 510, obtains power for driving the whole UWB transmitter/receiver 500.

Next, description will be given for an example of an operation to obtain, from the information processing apparatus 100, job congestion information of the plurality image forming apparatuses 106 and information to obtain distance between the information processing apparatus and the image forming apparatuses and orientation of the image forming apparatuses when viewed from the information processing apparatus, and an example of a screen display of response information.

Note that, the UWB wireless communication network 107 is connected to, in addition to the information processing apparatus 100 shown in FIG. 1, information processing apparatuses 100-1 and 100-2, where the information processing apparatuses 100 and 100-1 are desk top type PCs and the information processing apparatus 100-2 is a notebook type PC. Further, all of the first image forming apparatus 106a, the second image forming apparatus 106b and the third image forming apparatus 106c are color multifunctional peripherals and besides these apparatuses, a color printer 106d and a monochrome multifunctional peripheral 106e are also connected.

Such a case is assumed that, in the information processing apparatus 100, for example, application software to prepare a presentation material is started and a series of image data files are created, and then printed as a print job by the image forming apparatus 106.

When performing printing, various kinds of setting as to the printing is necessary and the setting is made after determining an image data file to be printed. The setting as to printing is made using a property screen as described below.

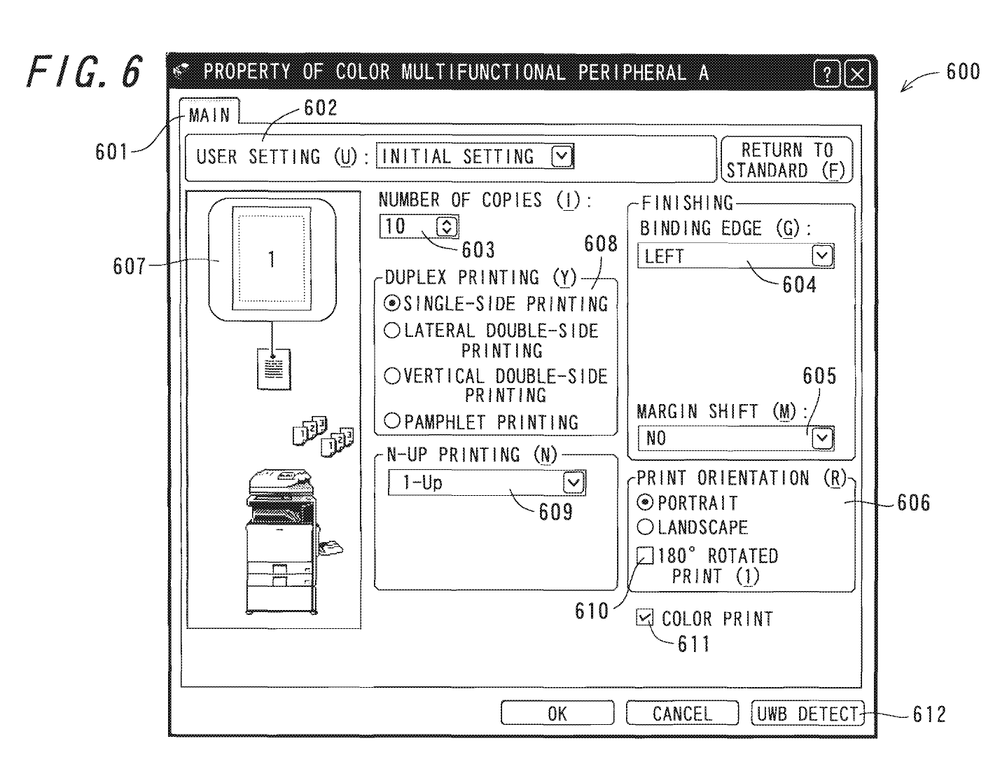

FIG. 6 is a diagram showing a print property screen 600 of the first image forming apparatus 106a which is a color multifunctional peripheral.

FIG. 6 shows a state of a main property 601 of a print property. In a user setting 602, several kinds of setting is possible, and the present example shows a state of initial setting. In a number of copies 603, the number from 1 to 99 can be selected, and it is set as 10 copies in the example. In a margin shift 604, setting of either “Yes” or “No” is possible, and it is set as “No” in the example. In the setting of a duplex printing 608, any one of single-side printing, lateral double-side printing, a vertical double-side printing, and pamphlet printing can be selected, and single-side printing is selected in the example.

An N-Up printing 609 shows the number of pages to be printed arranged on a single print sheet, where it is possible to select from the number 1 to 4. In the example, 1-Up is selected, where one page is printed on a single print sheet. In the setting of a binding edge 604, any one of left-binding, right-binding and top-binding can be selected, and in the example, left-binding is selected. In the setting of a print orientation 606, either portrait or landscape can be selected, and further, when an image is desirably rotated by 180° to print, a check box 610 is checked. In the example, portrait printing is selected without selecting rotated print.

In the check box 611, either color printing or monochrome printing can be selected, and in the example, the check box is checked to instruct color printing. A simple preview 607 shows, in graphics, a layout of a print image and that portrait printing is selected.

After the print setting as described above, when a UWB detection button 612 is selected with a pointer, an instruction to acquire each information is input, and as has been described above, job congestion information and information to obtain distance and orientation are acquired from the image forming apparatus 106 by UWB wireless communication. Based on the acquired response information, a detection screen of the image forming apparatus 106 is created and displayed on the monitor 110.

FIG. 7 is a diagram showing a display example of a detection screen 700.

On the detection screen 700, with the information processing apparatus 100 that has given an inquiry instruction at the center, displayed are job congestion information of the another information processing apparatus 100-1, the notebook type PC 100-2, in addition, the first color multifunctional peripheral 106a, the second color multifunctional peripheral 106b and the third color multifunctional peripheral 106c, the color printer 106d, the monochrome multifunctional peripheral 106e and the like, and orientation and distance thereof.

Taking the first color multifunctional peripheral 106a as an example, the first color multifunctional peripheral 106a has five jobs in print waiting and is positioned at orientation of the south west being separated by five to ten meters when viewed from the information processing apparatus 100.

When a UWB detection information button 701 within the detection screen 700 is selected with a pointer, a setting screen 800 shown in FIG. 8 is displayed.

The degree of job congestion in each of the image forming apparatuses 106 when viewed from the information processing apparatus 100 is taken along the X-axis, distance to the information processing apparatus 100 is taken along the Y-axis, and a time until printing of a print job to be transmitted from the information processing apparatus 100 is completed is taken along the Z-axis.

Correlation of print jobs assigned to each of the image forming apparatuses 106 from the information processing apparatus 100 is found by displaying in the same color as that of the information processing apparatus 100.

On the upper right of the screen, a volume of print waiting jobs (M bite) showing the job congestion state for each output destination apparatus, a volume of automatically assigned jobs (M bite), and a total volume of an output destination apparatus are shown in a table.

When some image forming apparatuses are selected among output destination apparatuses shown in the table (check boxes are checked), the selected image forming apparatuses, in the present example, three apparatuses of the color printer 106d, the first color multifunctional peripheral 106a and the second color multifunctional peripheral 106b, are set as output destinations, and print jobs to be transmitted are assigned to each of the image forming apparatuses by the output destination selecting section 104, so that outputting of the print jobs to be transmitted is completed in the shortest time. The table shows a result of the assignment. This is an example of a case when 10 copies of color printing (20M Byte/copy) are printed.

In the example shown in FIG. 8, optimum assignment of print jobs is obtained by calculating with the calculating section 103 so that the respective number of the TTL (total) jobs in three of the selected color printer 106d, the first color multifunctional peripheral 106a and the second color multifunctional peripheral 106b become minimum.

That is, in the table of FIG. 8, the print jobs are assigned for the unit of the number of copies so that maximum values of the TTL jobs in three of the selected color printer 106d, the first color multifunctional peripheral 106a and the second color multifunctional peripheral 106b become minimum.

In this way, by assigning the print jobs for the unit of the number of copies so that the maximum values of the TTL jobs become minimum, it is possible to set printing time so as to be the shortest time.

FIG. 9 shows another example of the setting screen 900.

The figure shows a case where ten copies of color printing (20M Byte/copy) are printed, in which jobs are assigned automatically, taking print speeds (CPM) of each of the image forming apparatuses 106 into consideration.

The calculating section 103 calculates so that an estimate print completion time of the selected image forming apparatus becomes minimum.

By taking print speed into consideration, printing is completed beginning from the nearest image forming apparatus so as to shorten the time to acquire printed matters.

Further, as to the order to acquire the printed matters, in reference to the setting screen 800 shown in FIG. 8 or the setting screen 900 shown in FIG. 9, it is possible to acquire with the shortest route and the shortest time.

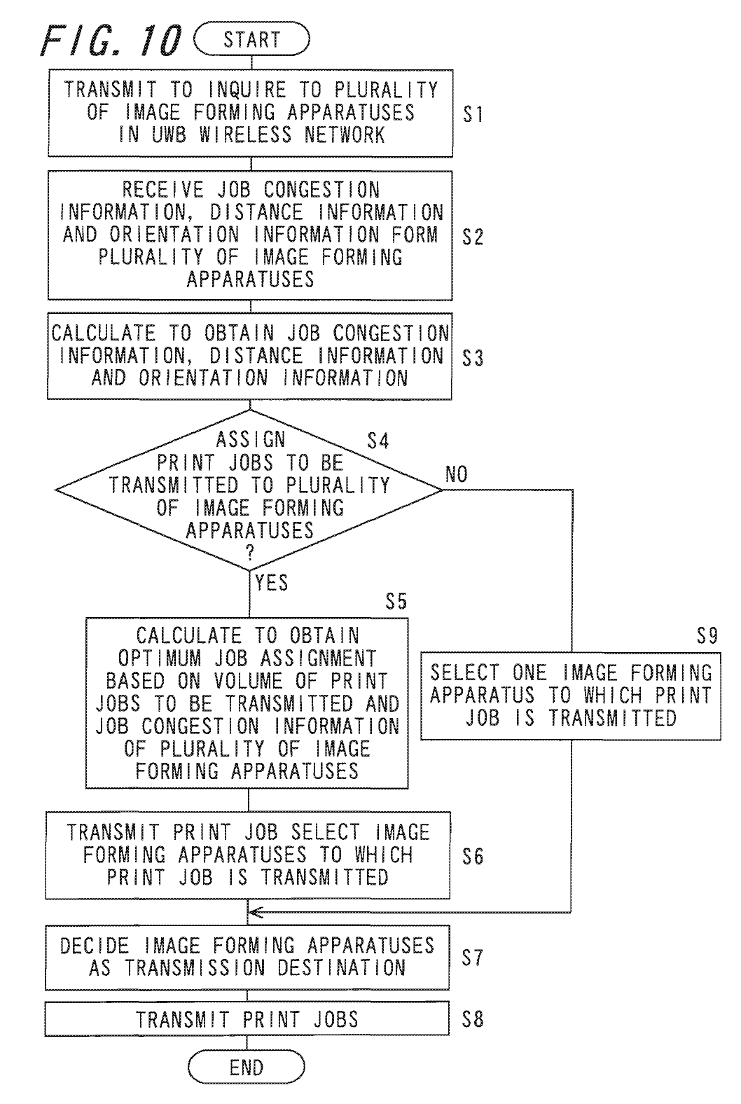

FIG. 10 is a flowchart showing processing of job assignment by the information processing apparatus 100. The figure shows the assignment process to determine a transmission destination when transmitting a print job from the information processing apparatus 100.

At step S1, with input instruction of a user from the input section 112a (such as a mouse or a keyboard), the operation state is inquired, through the user interface connecting section 111 and the control section 102, to image forming apparatuses connected to the UWB wireless communication network, to which the information processing apparatuses 100 is connected, and then the procedure proceeds to step S2.

At step S2, as response information to the inquiry, congestion information of print jobs, distance information, and orientation information are received from the image forming apparatuses, and then the procedure proceeds to step S3.

At step S3, based on the received response information, distance to each of the image forming apparatuses and orientation thereof when viewed from the informing apparatus 100 and job congestion information are obtained by calculation, and then the procedure proceeds to step S4.

At step S4, based on the calculation result, in order to determine whether to assign print jobs to be transmitted for a unit of the number of copies to the plurality of image forming apparatuses, the control section 102 causes the monitor 110 to display a screen for inputting assignment (the setting screen 800 of FIG. 8, or the setting screen 900 of FIG. 9) through the image output section 109.

When assigning the print jobs for the unit of the number of copies, the procedure proceeds to step S5, and when there is no image forming apparatus to assign to or when no assignment is made, the procedure proceeds to step S9.

At step S5, based on a volume of the print jobs to be transmitted and job congestion information of the plurality of image forming apparatuses, efficient assignment of the print jobs for the unit of the number of copies is calculated, and then the procedure proceeds to step S6.

At step S6, based on the calculation result, the plurality of image forming apparatuses to which the print jobs are transmitted for the unit of the number of copies is selected, and then the procedure proceeds to step S7.

At step S9, one image forming apparatus to which the print jobs are transmitted is selected, and then the procedure proceeds to step S7.

At step S7, the image forming apparatus to be a transmission destination is decided, and then the procedure proceeds to step S8.

At step S8, the print jobs are transmitted to the decided image forming apparatus as transmission destination, followed by completion of the processing.

The information processing apparatus 100 in the embodiment may be a mobile terminal 100a (PDA: Personal Digital Assistant) as shown in FIGS. 11 and 12.

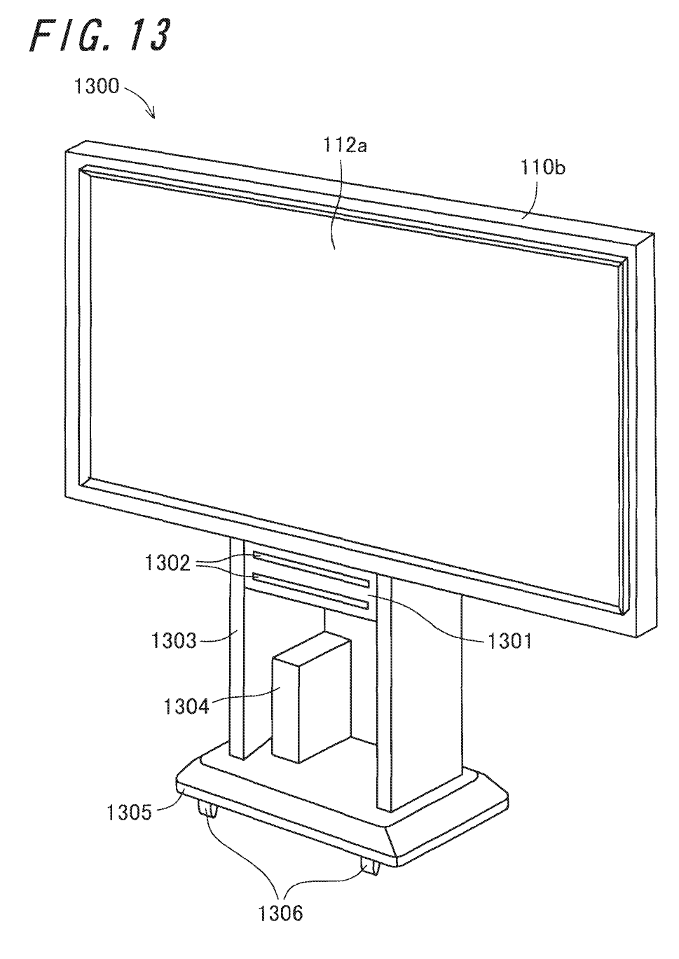

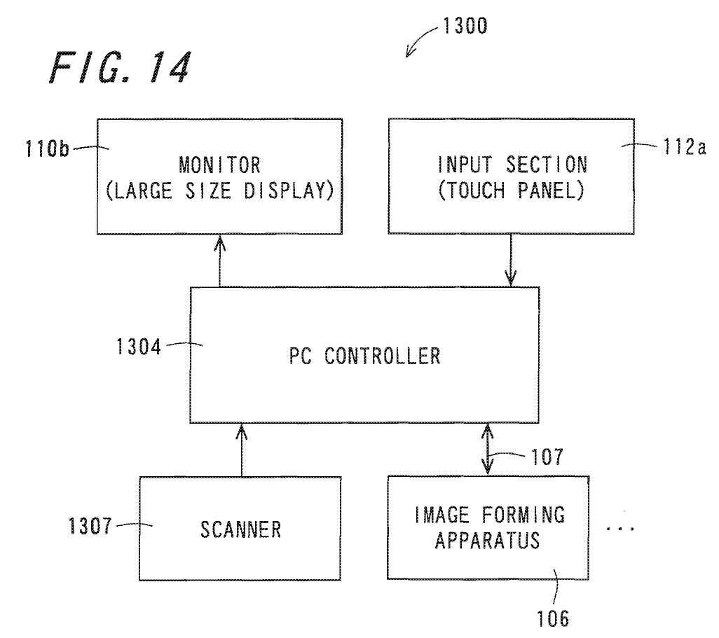

Further, it may be a display apparatus 1300 (an information display system in which a PC controller and a large size display are integrally systemized) shown in FIGS. 13 and 14.

### Second Embodiment

FIGS. 11 and 12 are perspective views of a mobile communication system 1100 according to a second embodiment of the invention.

The embodiment shows the mobile communication system 1100 capable of UWB wireless communication by inserting a USB connecting section 1101 of the second input section 112b (UWB wireless communication adaptor) allowing data communication by external connection to a USB port 111 of a mobile terminal 100a in the direction indicated by the arrow A.

FIG. 12 shows a state where the monitor 110a of the mobile terminal 100a is slid to expose the first input section 112a.

In place of the information processing apparatus 100 of the first embodiment, the mobile terminal 100a like in the second embodiment is employable.

By using the mobile terminal 100a, a user is able to acquire a desired printed matter at a movement destination of the user in a short time.

### Third Embodiment

FIG. 13 is a perspective view of the display apparatus 1300 (an information display system in which a PC controller and a large size display are integrally systemized).

The display apparatus 1300 includes the monitor (large size display) 110b, the first input section (touch panel) 112a, a scanner 1301, an opening 1302 from which a document is inserted or discharged to the scanner 1301, a leg 1303, a PC controller 1304, a base 1305, and a caster 1306.

FIG. 14 is a block diagram of the display apparatus 1300.

The UWB wireless communication section is incorporated in the PC controller 1304 and is connected through UWB wireless communication network 107 to the plurality of image forming apparatuses 106.

The monitor (large size display) 110b, the first input section (touch panel) 112a, and the scanner 1301 are connected to the PC controller 1304 through a USB, a UWB, a wireless LAN and the like, which are not shown.

In place of the information processing apparatus 100 of the first embodiment, the display apparatus 1300 like in the third embodiment is employable.

The display apparatus 1300 is a large size display and whose size is larger than that of a general home-use display, indicating a display having about 40 inches or more.

As a display, preferably used are a liquid crystal display, a PDP (Plasma Display Panel), an organic electroluminescence display, an FED (Field Emission Display), an SED (Surface-conduction Electron-emitter Display), a PTA display (Plasma Tube Array Display) and the like.

By using the display apparatus 1300, it is possible to display a display image clearly with a larger size, thus improving visibility and operability.

### Fourth Embodiment

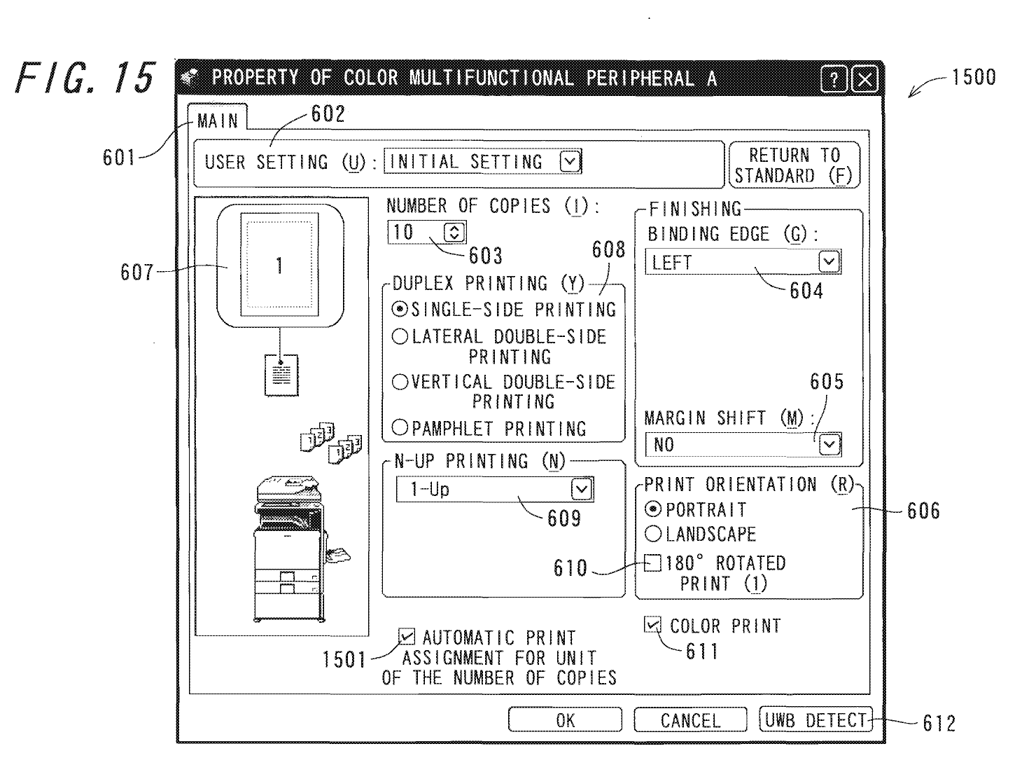

In this embodiment, instead of the print property screen 600 shown in FIG. 6, a print property screen 1500 shown in FIG. 15 is used to perform setting.

Difference between the print property screen 1500 and a print property screen 600 shown in FIG. 6 is that a check box 1501 for setting whether or not printing is automatically assigned for a unit of the number of copies, and it is possible to automatically assign printing for a unit of the number of copies by checking the check box 1501.

Description will hereinafter be given for processing of automatically assigning printing for a unit of the number of copies when the check box 1501 showing automatic assignment of printing for a unit of the number of copies is checked.

The calculating section 103 calculates to obtain a print completion time of the waiting job volume (M bite) in consideration of the print processing volume (M bite/second) for each image forming apparatus. An example of the calculation result is shown in the Table 1.

TABLE 1

| Example of image | Volume of print | Volume of | |
|---|---|---|---|
| forming apparatuses | processing | waiting job | Print completion |
| 106 | (M bite/second) | (M byte) | time a (second) |
| Monochrome | 0.5 | 9.0 | 18.0 |
| multifunctional | | | |
| peripheral 106e | | | |
| Color printer 106d | 0.2 | 2.0 | 10.0 |
| First color | 0.4 | 6.0 | 15.0 |
| multifunctional | | | |
| peripheral 106a | | | |
| Second color | 0.6 | 12.0 | 20.0 |
| multifunctional | | | |
| peripheral 106b | | | |
| Third color | 1.0 | 20.0 | 20.0 |
| multifunctional | | | |
| peripheral 106c | | | |

The example shown in the Table 1 shows that the print completion time of waiting jobs in the monochrome multifunctional peripheral 106e is 18 seconds, and the print completion time of the waiting jobs in the color printer 106d is 10 seconds. Similarly, it is shown that the respective print completion times of the waiting jobs are 15 seconds in the first color multifunctional peripheral 106a, 20 seconds in the second color multifunctional peripheral 106b, and 20 seconds in the third color multifunctional peripheral 106c.

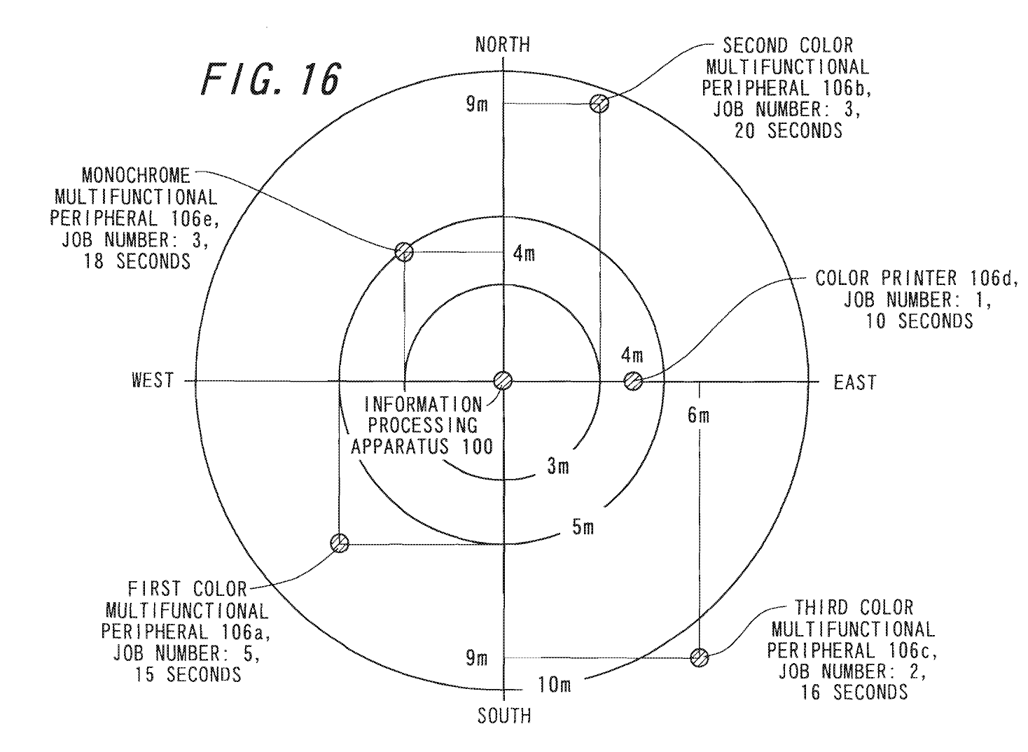

Here, the display example of the print completion time of the waiting jobs as shown in FIG. 7 is converted to be displayed with coordinate axes. FIG. 16 shows an example of converted display of coordinate axes. In the example shown in FIG. 16, a name, the number of waiting jobs (same meaning as the volume of waiting job), print completion time of the waiting jobs in each of the image forming apparatuses are displayed.

Based on distance to each of the image forming apparatuses and orientation thereof when viewed from the information processing apparatus 100, a time required until a user who carries the information processing apparatus 100 reached each of the image forming apparatuses is obtained by calculation.

The conditions in calculation of a time required are as follows:
(1) A speed that user moves is 1 m/s. (3.6 km/h)
(2) The job to be printed by a user's request has the 10 copies of full-color prints, where a processing volume per one copy is 2M byte and a total processing volume is 20M byte.
(3) In order to reduce movement of a user to acquire a printed matter in the shortest time, an image forming apparatus that a movement distance of a user is shorter (a time required is shorter) is preferentially determined as an image forming apparatus from which the printed matter is acquired.

Similarly, a route taking shorter movement time of the user is given a priority to determine a movement route to an image forming apparatus from which the printed matter is secondly acquired. The same applies to the followings. This is to prevent the printed matter from being read by the third person during movement of the user.

Here, since the user desires color printing, calculation is made by previously excluding the monochrome multifunctional peripheral 106e as the assignment destination. The remaining color printer 106d, the first color multifunctional peripheral 106a, the second color multifunctional peripheral 106b, and the third color multifunctional peripheral 106c are subject to the calculation.

Next, an image forming apparatus from which the user is able to acquire a copy of the print job in the shortest time is obtained by calculation.

First, linear distance from a present position of the user to each of the image forming apparatuses is obtained by Pythagorean theorem (three-square theorem).

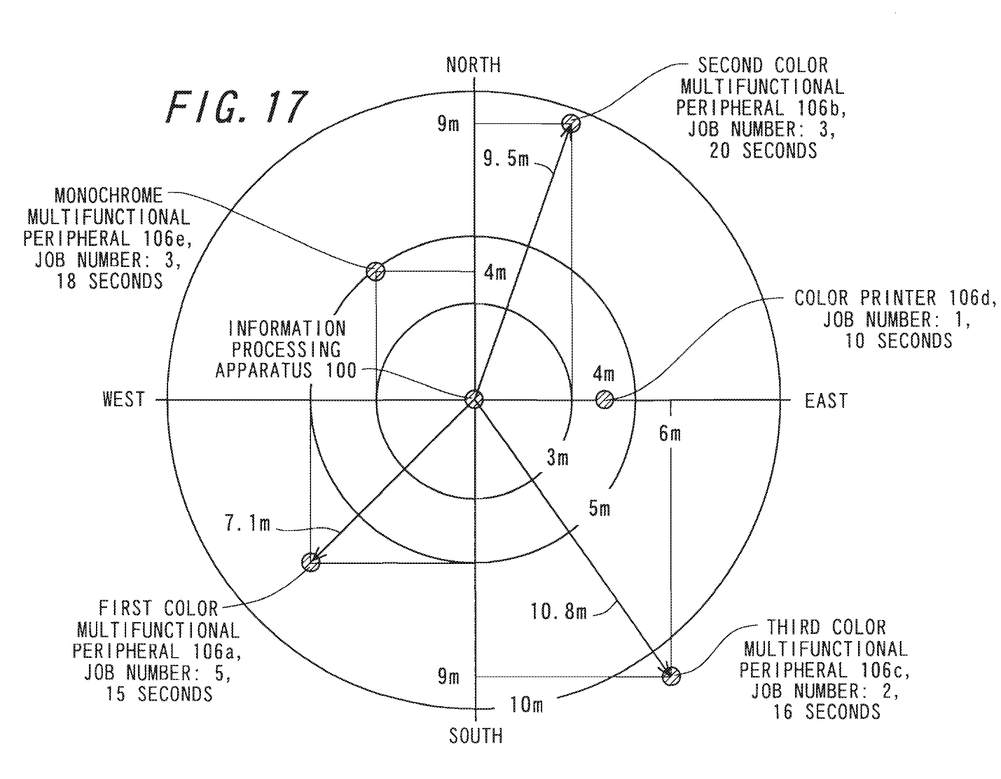

FIG. 17 is a schematic view showing linear distance from a present position of a user (the image forming apparatus 100) to each of the image forming apparatuses. Based on the obtained linear distance, a time b, a time c and a time a+c are calculated. Herein, the time b means a time until a user reached an image forming apparatus, the time c means a time until a copy of print job is completed, and the time a+c means a time until the user acquires the one copy of print job.

Table 2 shows an example of the obtained times a to c.

TABLE 2

| | | | Print | | Time until one copy | Time until user |
|---|---|---|---|---|---|---|
| Example of image | Volume of print | Volume of | completion | Movement time | of print job is | acquires one copy of |
| forming apparatuses | processing | waiting job | time | until user reaches | completed | print job |
| 106 | (M bite/second) | (M bit) | (second) | b (second) | c (second) | a + c (second) |
| Monochrome | 0.5 | 9.0 | 18.0 | — | — | — |
| multifunctional | | | | | | |
| peripheral 106e | | | | | | |
| Color printer 106d | 0.2 | 2.0 | 10.0 | 4.0 | 10.0 | 20.0 |
| First color | 0.4 | 6.0 | 15.0 | 9.5 | 5.0 | 20.0 |
| multifunctional | | | | | | |
| peripheral 106a | | | | | | |
| Second color | 0.6 | 12.0 | 20.0 | 7.1 | 3.3 | 23.3 |
| multifunctional | | | | | | |
| peripheral 106b | | | | | | |
| Third color | 1.0 | 20.0 | 20.0 | 10.8 | 2.0 | 22.0 |
| multifunctional | | | | | | |
| peripheral 106c | | | | | | |

When the calculation condition (3) is applied and the first copy is transmitted to the color printer 106d which is positioned 4 meters apart in the east, the user is able to acquire the first copy in the shortest time. Note that, the time (second) required to acquire a copy of the print job by the user is not included in a time until the user reaches an image forming apparatus. This is because, assuming that the user transmits the print job and moves toward a color printer 106d at the same time, print execution and the movement of the user are simultaneously advanced and the movement time (second) until the user reached is to be included in the time (second) required to acquire one copy of the print job by the user.

Subsequently, for the second copy, an image forming apparatus that the movement distance by the user is the shortest, that is, an image forming apparatus nearest from the color printer 106d which outputs the first copy is obtained. This is obtained by calculation using a triangular method.

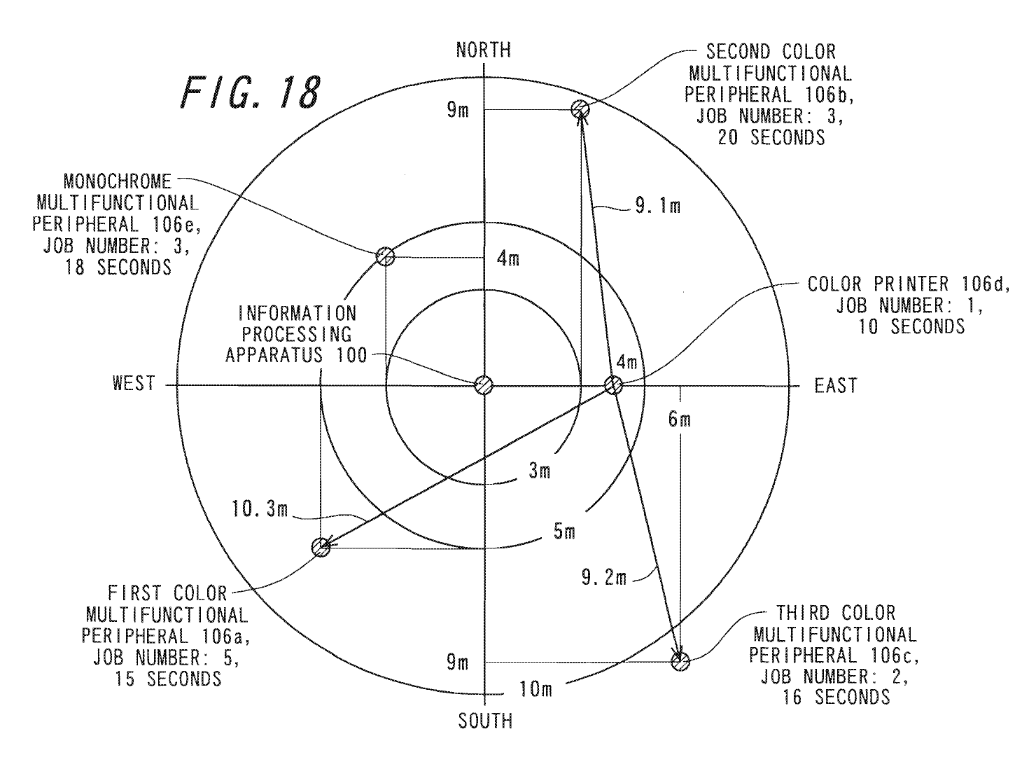

FIG. 18 is a schematic view showing linear distance from a position of a user (color printer 106d) to each of the image forming apparatuses.

As shown in FIG. 18, it is found that an image forming apparatus that is nearest from the color printer 106d is the second color multifunctional peripheral 106b that is positioned 9.1 m away from the color printer 106d in linear distance.

Accordingly, in assignment of 10 copies of color print, the priority order is obtained as follows; the color printer 106d has the first priority, the second color multifunctional peripheral 106b has the second priority, the color printer 106d has also the third priority, the third color multifunctional peripheral 106c has the fourth priority, and the first color multifunctional peripheral 106a has the fifth priority. Here, in order to shorten the movement distance of the user, the calculating section 103 preferably calculates so that print jobs are assigned to image forming apparatuses within a range not exceeding 20 m with a threshold of the movement distance of the user as 20 m.

In consideration of such a threshold, the print jobs are to be assigned to the color printer 106d having the first priority and the second color multifunctional peripheral 106b having the second priority.

Based on the calculation result, in consideration of the volume of print processing (M byte/second) and the print completion time a (second) shown in the Table 2, the calculating section 103 obtains the movement time, the waiting job completion time, the number of assigned print jobs, the print completion time and the time until the user acquires a printed matter with respect to the color printer 106d having the first priority and the second color multifunctional peripheral 106b having the second priority. The Table 3 shows an example of the calculation result.

TABLE 3
First priority

| | Waiting job | | | |
|---|---|---|---|---|
| | completion | Number of print | | Time required |
| Movement time | time in color | jobs assigned to | Print completion time | until user acquires |
| to color printer | printer | color printer | in color printer | color print |
| a (second) | b (second) | (copy) | c (second) | b + c (second) |
| 4.0 | 10.0 | 1 | 4.0 | 14.0 |
| 4.0 | 10.0 | 2 | 8.0 | 18.0 |
| 4.0 | 10.0 | 3 | 12.0 | 22.0 |
| 4.0 | 10.0 | 4 | 16.0 | 26.0 |
| 4.0 | 10.0 | 5 | 20.0 | 30.0 |
| 4.0 | 10.0 | 6 | 24.0 | 34.0 |
| 4.0 | 10.0 | 7 | 28.0 | 38.0 |
| 4.0 | 10.0 | 8 | 32.0 | 42.0 |
| 4.0 | 10.0 | 9 | 36.0 | 46.0 |
| 4.0 | 10.0 | 10 | 40.0 | 50.0 |

Second priority

| Movement time | Waiting job | | | |
|---|---|---|---|---|
| from color | completion | Number of print | | |
| printer to | time in | jobs assigned to | Print completion time | |
| second color | second color | second color | in second color | Time required |
| multifunctional | multifunctional | multifunctional | multifunctional | until user acquires |
| peripheral | peripheral | peripheral | peripheral | color print |
| d (second) | e (second) | (copy) | f (second) | e + f (second) |
| 9.1 | 7.1 | 9 | 30.0 | 37.1 |
| 9.1 | 7.1 | 8 | 26.7 | 33.8 |
| 9.1 | 7.1 | 6 | 23.3 | 30.4 |
| 9.1 | 7.1 | 7 | 20.0 | 27.1 |
| 9.1 | 7.1 | 5 | 16.7 | 23.8 |
| 9.1 | 7.1 | 4 | 13.3 | 20.4 |
| 9.1 | 7.1 | 3 | 10.0 | 17.1 |
| 9.1 | 7.1 | 2 | 6.7 | 13.8 |
| 9.1 | 7.1 | 1 | 3.3 | 10.4 |
| 9.1 | 7.1 | 0 | 0.0 | 7.1 |

Here, the movement time to the color printer 106d a (second), the print completion time in the color printer c (second) and the movement time from the color printer 106d to the second color multifunctional peripheral 106b d (second), and the print completion time f (second) in the second color multifunctional peripheral 106b are the times of processing advanced simultaneously, resulting that the time required until the user can acquire the color print which is the printed matter from each of the image forming apparatuses can be shown by b+c (second) and e+f (second).

In addition, the times required until the user can acquire the color print b+c (second) and e+f (second) also show the time of processing advanced simultaneously. That is, when the number of print jobs (copy) assigned to the color printer 106d is X and the number of print jobs (copy) assigned to the second color multifunctional peripheral 106b is Y, X (copy)+Y (copy)=10 (copies), where X (copy) and Y (copy) may be obtained so that the each time required until the user can acquire the color print b+c (second) and e+f (second) satisfies a minimum value.

Based on the calculation result shown in the Table 3, when the number of jobs assigned to the color printer 106d X and the number of jobs assigned to the second color multifunctional peripheral 106b Y are varied from X=1 and Y=9 to X=9 and Y=1, the time required until the user can acquire the 10 copies of printed matter is calculated. An example of the calculation result is shown in the Table 4.

TABLE 4

| First priority | | | Second priority | | | |
|---|---|---|---|---|---|---|
| Number of | | Time required | Number of print jobs | Print completion | Time required | Shortest time requried |
| print | Print completion | until user can | assigned to second | time in second color | until user can | until user 10 copies of |
| jobs assigned | time in color | acquire color | color multifunctional | multifunctional | acquire color | color print can be |
| to color printer | printer | print | peripheral | peripheral | print | acquired |
| (copy) | c (second) | b + c (second) | (copy) | f (second) | e + f (second) | (second) |
| 1 | 4.0 | 14.0 | 9 | 30.0 | 37.1 | 37.1 |
| 2 | 8.0 | 18.0 | 8 | 26.7 | 33.8 | 33.8 |
| 3 | 12.0 | 22.0 | 7 | 23.3 | 30.4 | 30.4 |
| 4 | 16.0 | 26.0 | 6 | 20.0 | 27.1 | 27.1 |
| 5 | 20.0 | 30.0 | 5 | 16.7 | 23.8 | 30.0 |
| 6 | 24.0 | 34.0 | 4 | 13.3 | 20.4 | 34.0 |
| 7 | 28.0 | 38.0 | 3 | 10.0 | 17.1 | 38.0 |
| 8 | 32.0 | 42.0 | 2 | 6.7 | 13.8 | 42.0 |
| 9 | 36.0 | 46.0 | 1 | 3.3 | 10.4 | 46.0 |
| 10 | 40.0 | 50.0 | 0 | 0.0 | 7.1 | 50.0 |

The table 4 shows that the shortest time required until the user can acquire 10 copies of printed matter is 27.1 seconds, where the number of print jobs assigned to the color printer 106d is 4 copies and the number of print jobs assigned to the second color multifunctional peripheral 106b is 6 copies.

Based on the result above, the control section 102 gives an instruction to the image output section 109 to visualize the movement route to each of the image forming apparatuses, to which the print jobs are assigned, from the current position of the user, and the image output section 109 displays the movement route on the monitor 110.

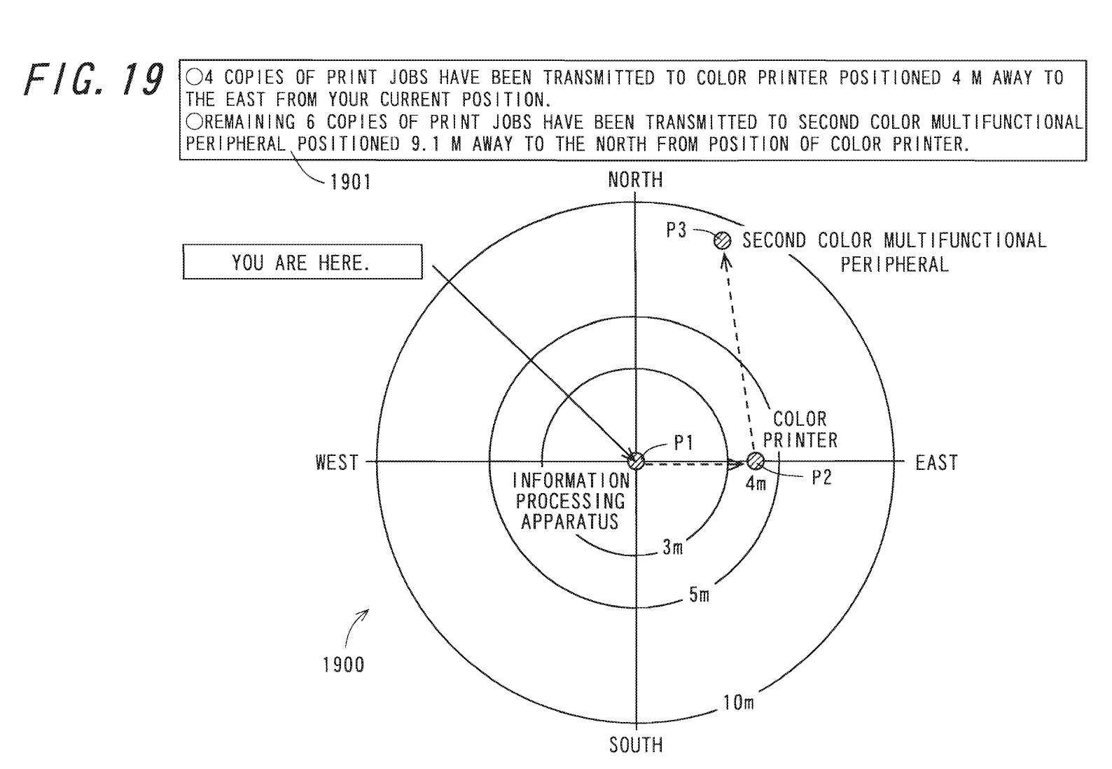

FIG. 19 is a view showing a display example of a movement route displayed on the monitor 110. In the example shown in FIG. 19, it is assumed that the number of print jobs assigned to the color printer 106d is 4 copies and the number of print jobs assigned to the second color multifunctional peripheral 106b is 6 copies based on the calculation result. Guide display of the movement route is composed of a current position, positions of image forming apparatuses, a map section 1900 for displaying an arrow and the like indicative of the movement process, and a comment section 1901 for displaying detailed information with characters and the like.

On the map section 1900, an intersection point of coordinate axes perpendicular to each other displayed with north, south, east, and west is displayed as the current position P1 of the user (position of the information processing apparatus 100 in this example), and a position P2 of the color printer 106d and a position P3 of the second color multifunctional peripheral 106b, to which the jobs are assigned, are displayed, respectively.

In order to display the current position P1 in an easy-to-understand manner, characters of “You are here” and an arrow showing the intersection point of coordinate axes are displayed.

An arrow from P1 to P2 is displayed to guide the route from the current position P1 to the position P2 of the color printer 106d, from which the first 4 copies are outputted, and an arrow from P2 to P3 is displayed to guide the route to the position P3 of the second color multifunctional peripheral 106b, from which 6 copies are outputted.

Further, the comment section 1901 displays a direction from the current position to an image forming apparatus subjected to the assignment, distance, the number of assigned jobs, and the like.

In the display example, the comment section 1901 displays that 4 copies have been assigned to the color printer 106d positioned 4 m away from the current position in the east, and remaining 6 copies have been assigned to the second color multifunctional peripheral 106b positioned further 9.1 m from the color printer 106d in the north.

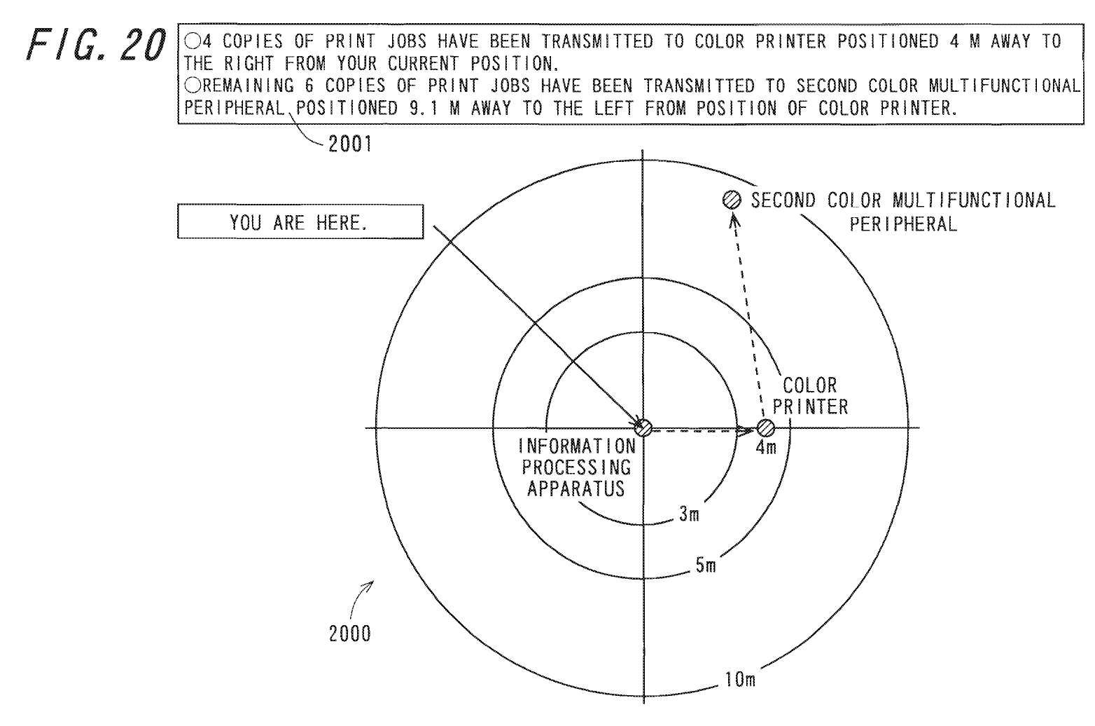

FIG. 20 is a view showing another display example of a movement route to be displayed on the monitor 110. Similarly to the example shown in FIG. 19, it is composed of a map section 2000 and a comment section 2001, where the direction is not shown as north, south, east, and west, but the direction in which the color printer 106d is positioned toward the information processing apparatus 100 and the direction in which the second color multifunctional peripheral 106b is positioned toward the color printer 106d are shown as vertical and horizontal directions.

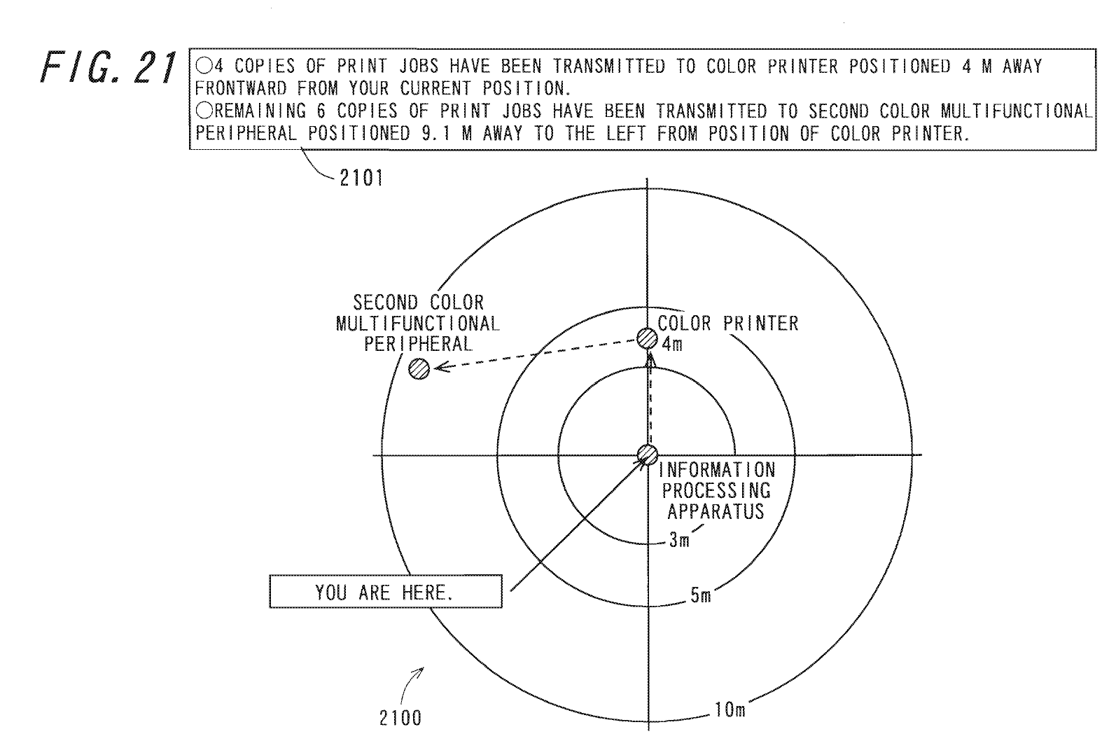

FIG. 21 is a view showing a display example where display on a map section is changed due to change in the direction of a user. Display content of a map section 2100 and a comment section 2101 in this example is based on the example shown in FIG. 20, and when a user changes direction of his/her body to the direction of the color printer 106d, that is, when the direction of the information processing apparatus 100 is changed toward the color printer 106d, the position of the color printer 106d is changed to be displayed frontward from the current position and upward in the display of the map section 2100.

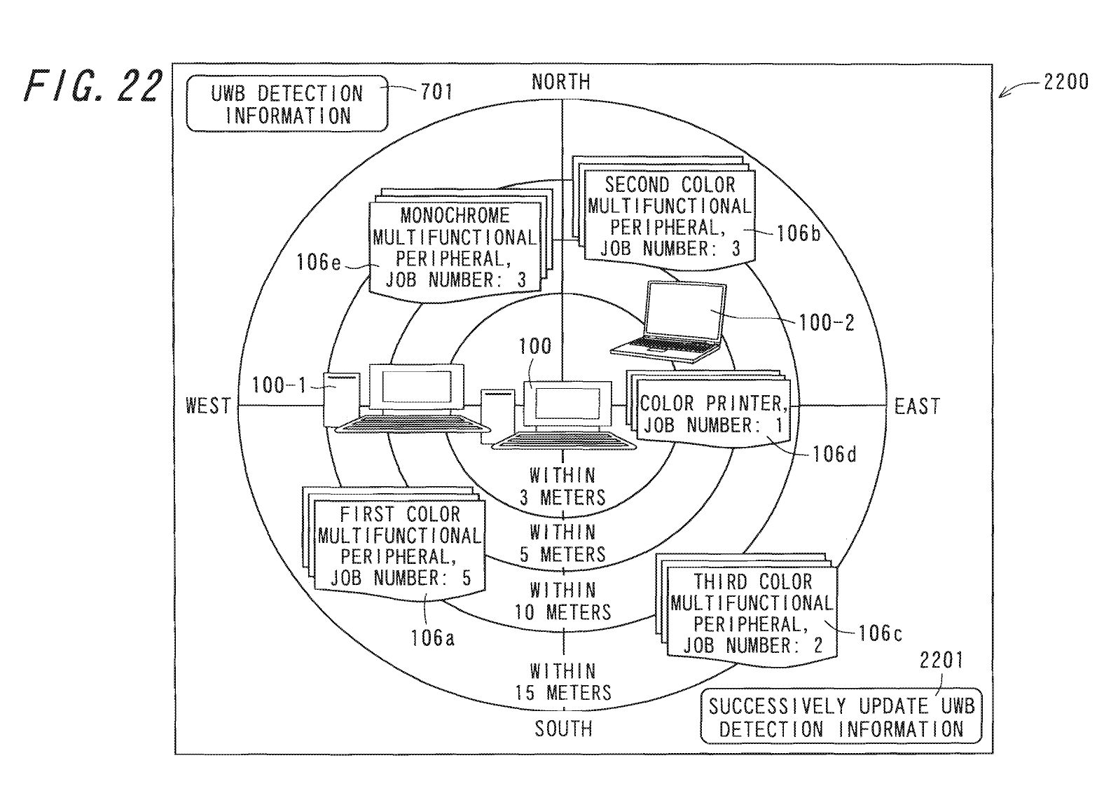

Moreover, a detection screen (for example, the detections screen 700) of the image forming apparatuses 106 is created based on acquired response information, and, at this time, when the detection screen is configured so as to update UWB detection information one after another, the response information is acquired in the short time so that change in conditions of the image forming apparatuses 106 can be acquired in each case and the display of the movement route as shown in FIGS. 21 and 22 can be realized by mutual communication to each of the image forming apparatuses 106.

FIG. 22 is a view showing a display example of a detection screen 2200. FIG. 22 shows the display example similar to in the detection screen 700, where an input button 2201 for instructing update of UWB detection information sequentially is provided and by inputting with this, for example, response information is acquired for every several seconds so that mutual communication with each of the image forming apparatuses 106 can be successively performed.

Furthermore, when the current position of the user is changed, the display on the map section is preferably changed in accordance with the change.

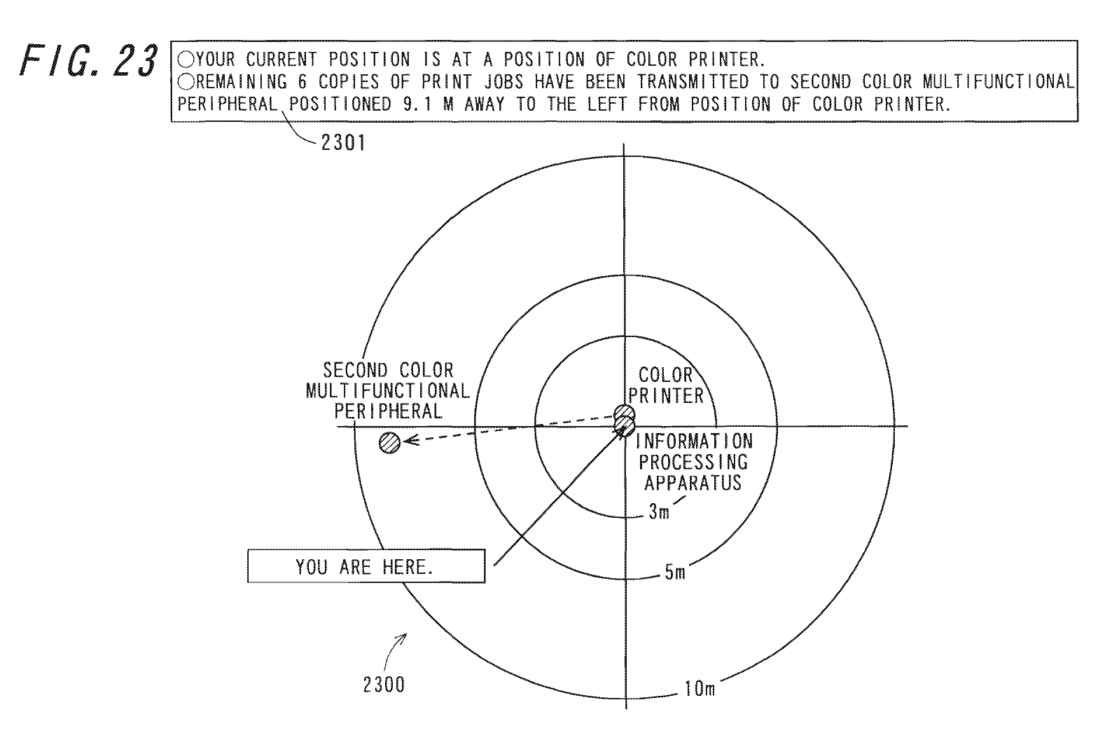

FIG. 23 is a view showing a display example where display on a map section is changed due to change in the current position of a user. Display content of a map section 2300 and a comment section 2301 in this example is based on the example shown in FIG. 21, and when a user reaches the color printer 106d and the current position is changed to the position of the color printer 106d, that is, when the current position of the information processing apparatus 100 is changed to be overlapped with the position of the color printer 106d, the position of the current position P1 is not changed from the intersection position of the coordinate axes but each of the position P2 of the color printer 106d and the position P3 of the second color multifunctional peripheral 106b are relatively changed and displayed.

The comment section 2301 shows that the current position is at the position of the color printer 106d, and the remaining 6 copies have been assigned to the second color multifunctional peripheral 106b positioned 9.1 m away to the left from the current position.

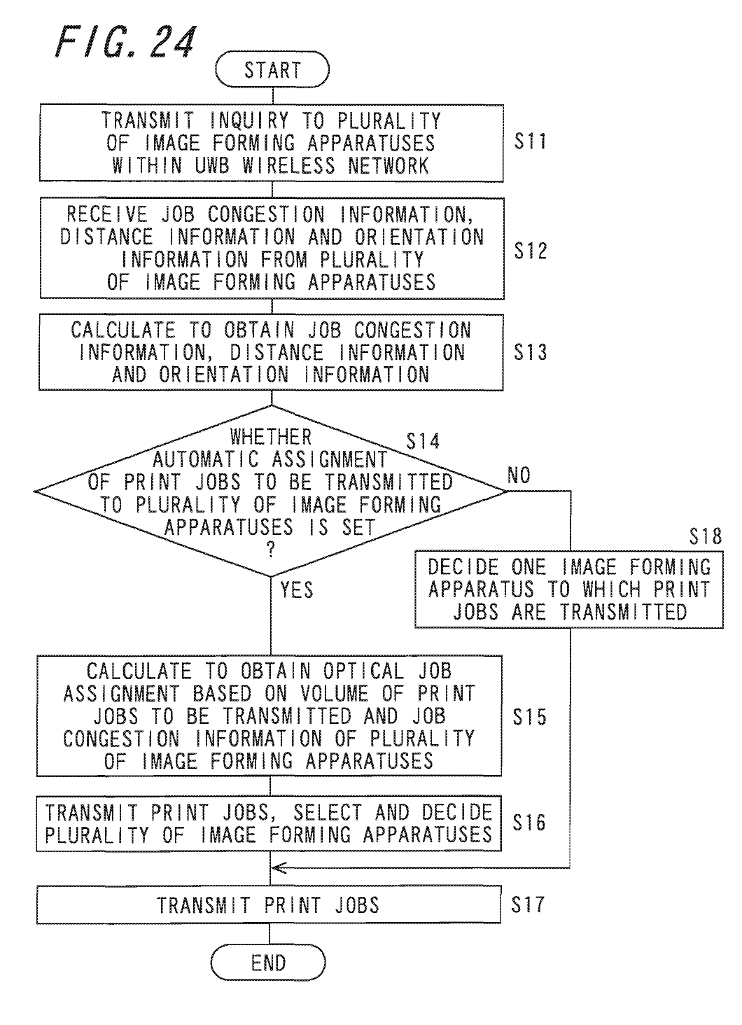

FIG. 24 is a flowchart showing another example of job assignment processing by the information processing apparatus 100.

At step S11, upon input instruction from a user with the input section 112a (such as mouse or keyboard), an inquiry of operation state is given to each of the image forming apparatuses connected to the UWB wireless communication network to which the information processing apparatus 100 is connected through the user interface connecting section 111 and the control section 102, and the procedure proceeds to step S12.

At step S12, as response information to the inquiry, congestion information of print jobs, distance information, and orientation information are received from each of the image forming apparatuses, and the procedure proceeds to step S13.

At step S13, based on received response information, distance to each of the image forming apparatuses when viewed from the information processing apparatus 100, orientation thereof, and job congestion information are calculated and obtained, and the procedure proceeds to step S14.

At step S14, it is determined whether or not automatic assignment to a plurality of image forming apparatuses is set for a unit of the number of copies. The setting of the automatic assignment can be determined based on whether or not the check box 1501 of the print property screen 1550 is checked.

When print jobs are automatically assigned for a unit of the number of copies, the procedure proceeds to step S15, alternatively, when automatic job assignment is not set, the procedure proceeds to step S18.

At step S15, based on the volume of print jobs to be transmitted and job congestion information in a plurality of image forming apparatuses, efficient assignment of the print jobs for a unit of the number of copies is obtained by calculation, and then the procedure proceeds to step S16.

At step S16, based on the calculation result, automatic assignment for a unit of the number of copies is performed and a plurality of image forming apparatuses subjected to transmission are selected and decided, and then the procedure proceeds to step S17.

At step S18, an image forming apparatus to which the print jobs are transmitted is decided, and then the procedure proceeds to step S17.

At step S17, the print jobs are transmitted to the decided image forming apparatus as a transmission destination, followed by completion of the processing.

Note that, in the above, in order to shorten the movement distance of the user, it has been described that the threshold of the movement distance of the user is set in 20 m, but without limitation thereto, and that calculation is performed so that the print jobs are assigned to two image forming apparatuses within a range not exceeding 20 m, but the number is not limited to two, it is also possible to automatically assign the print jobs for a unit of the number of copies to three or more image forming apparatuses.

As has been described above, the information processing apparatus 100 includes a program for causing a plurality of image forming apparatuses like in the embodiment to automatically assign for a unit of the number of copies so that the plurality of copies of print jobs by the user can be acquired in the shortest time.

Description has been made with reference to the impulse system as the USB wireless communication system of the invention, but without limitation thereto, a DS-UWB system in which two bands of a low band and a high band are used as the bandwidth of 3.1 to 10.6 GHz, avoiding a bandwidth used for the 802.11a wireless LAN, or an MB-OFDM system in which the bandwidth of 3.1 to 10.6 GHz is divided into 14 bands for a unit of 528 MHz are also applicable.

As still another embodiment of the invention, it is also possible to provide a program code of an information processing program for causing a computer to operate as the information processing apparatus 100 and a computer readable recording medium having the program code of the information processing program recorded therein.

Note that, as the recording medium, a memory for processing performed in a micro processor, for example, a ROM itself may be the recording medium, or it may be a recording medium which can be read by inserting into a program reading device, which is provided as an external storage section of a computer.

In any case, the program code of the recorded information processing program may be executed when the micro processor accesses the recording medium, or may be executed when the micro processor read the program code from the recording medium and downloads the read program code in a program storage area. Note that, the program for downloading is previously stored in a predetermined storage device. The micro processor such as a CPU integrally controls each section in the computer so that predetermined update processing is performed in accordance with the installed program for information processing.

Furthermore, the recording medium which can be read by a program reading device may be provided in any forms of recording medium including tapes such as a magnetic tape and a cassette tape, discs such as a magnetic disc including a flexible disc and a hard disc or an optical disc such as CD-ROM (Compact Disc-Read Only Memory)/MO (Magneto Optical disc)/MD (Mini Disc)/DVD (Digital Versatile Disc), Blu-ray Disc, cards such as an IC (Integral Circuit) card (including a memory card)/an optical card, or a medium for fixedly recording a program including semiconductor memories such as a mask ROM, an EPROM (Erasable Programmable Read Only Memory), an EEPROM (Electrically Erasable Programmable Read Only Memory), and a flash ROM.

Furthermore, when the computer is configured so as to be connectable with a communication network including Internet, it may be a medium that carries a program in a flowing manner so as to download the program code of the information processing program from a communication network. Note that, when the information program is downloaded from a communication network in this way, a program for downloading may be previously stored in a computer or may be installed from another recording medium. Note that, the invention is also realized in the form of computer data signal embedded in carrier wave, where the program code is embodied by electrical transmission.

An example of a computer system for executing the program code of the information processing program read from the recording medium includes a system that is configured by mutually connecting a computer for performing various processing including the information processing method by executing various kinds of programs, an image display apparatus such as a CRT (Cathode Ray Tube) display and a liquid crystal display for displaying processing results of the computer and the like, and an image output apparatus such as a printer for outputting the processing result of the computer on sheets of paper or the like. Furthermore, the computer system includes a modem for connecting a communication network to a server and the like to transmit/receive various kinds of programs including an information processing program and various kinds of data such as image data.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and a range of equivalency of the claims are therefore intended to be embraced therein.

What is claimed is:

1. An information processing apparatus that is capable of wireless communication with a plurality of image forming apparatuses and controls transmission of print jobs to the image forming apparatuses, comprising:
a data communication section for receiving congestion information of print jobs in the plurality of image forming apparatuses, and information to obtain distance between the information processing apparatus and the image forming apparatuses and orientation of the image forming apparatuses when viewed from the information processing apparatus;
a calculating section for calculating, based on the information received by the data communication section, distance to the image forming apparatuses to be transmission destination of print jobs and orientation thereof;
a deciding section for deciding the image forming apparatuses obtained at the calculating section; and
a control section for controlling transmission of print jobs to the image forming apparatuses decided by the deciding section.

2. The information processing apparatus of claim 1, wherein the data communication section performs communication of information with the plurality of image forming apparatuses by UWB wireless communication.

3. The information processing apparatus of claim 1, wherein the data communication section is incorporated in the information processing apparatus and the plurality of image forming apparatuses or is externally connected thereto.

4. A method for controlling print jobs, wherein a plurality of image forming apparatuses and an information processing apparatus are constructed so as to be capable of wireless communication and the information processing apparatus controls transmission of print jobs to the image forming apparatuses, comprising:
receiving congestion information of print jobs in the plurality of image forming apparatuses, and information to obtain distance between the information processing apparatus and the image forming apparatuses and orientation of the image forming apparatuses when viewed from the information processing apparatus;
calculating, based on the received information, distance to the image forming apparatuses to be transmission destinations of print jobs and orientation thereof;
deciding the image forming apparatuses calculated and obtained by the calculating section; and
controlling transmission of print jobs to the decided image forming apparatuses.

5. A recording medium having an information processing program for causing a computer to function as the information processing apparatus of claim 1, recorded thereon.
